(19) United States
(12) Patent Application Publication
(10) Pub. No.: US 2015/0206254 A1
(43) Pub. Date: Jul. 23, 2015

(54) SYSTEM AND METHOD OF INTEGRATING VARIOUS PLATFORMS AND METHODS OF USING THE SAME

(71) Applicants: Joheem Loh, San Jose, CA (US); Randall Elke, San Jose, CA (US)

(72) Inventors: Joheem Loh, San Jose, CA (US); Randall Elke, San Jose, CA (US)

(21) Appl. No.: 14/608,182

(22) Filed: Jan. 28, 2015

Related U.S. Application Data
(63) Continuation-in-part of application No. 14/014,336, filed on Aug. 29, 2013.
(60) Provisional application No. 61/694,252, filed on Aug. 29, 2012.

(51) Int. Cl. G06Q 50/00; H04L 29/08

(52) U.S. Cl. CPC G06Q 50/01; H04L 67/10

(57) ABSTRACT

The present invention relates generally to systems and methods of integrating various platforms and streams, including social platforms and streams as well as networking, customer management, targeted marketing, and enterprise operations relating to the systems and methods. The present invention also includes methods of using the above integration, networking, publishing aggregation, marketing, and enterprise solutions.

### CROSS-REFERENCE TO RELATED APPLICATIONS

This application is a continuation-in-part of U.S. patent application Ser. No. 14/014,336, tiled on Aug. 29, 2013, which is a continuation-in-part of U.S. patent application Ser. No. 13/136,855 filed on Aug. 12, 2011, and claims priority to U.S. Provisional Patent Application 61/932,754, filed on Jan. 28, 2014, all of which are incorporated by reference in their entireties.

### FIELD OF THE INVENTION

The present invention relates generally to systems and methods of integrating various platforms and streams, including social platforms and streams as well as networking, customer management, targeted marketing, and enterprise operations relating to the systems and methods.

### BRIEF DESCRIPTION OF THE FIGURES

FIG. 1 shows aspects of an example of a method of aggregating and publishing media according to certain embodiments of the present invention

FIG. 2 shows an example of an interactive user screen according to aspects of an embodiment of the present invention.

FIG. 3 shows an example of a block diagram of steps of a media pull from an exemplary social page.

FIG. 4 shows an example of a block diagram of a file synchronization system according to embodiments of the present invention.

FIG. 5 shows an example of a chart of certain feature definitions and specifications according to an embodiment of the present invention relating to a data caching system in a Socxs implementation.

FIG. 6 shows an example of an overview of certain aggregation and publication processes according to an embodiment of the present invention.

FIGS. 7a and 7b show examples of screen shots according to an embodiment of the present invention.

FIGS. 8a and 8b show examples of screen shots according to an embodiment of the present invention.

FIG. 9 shows an example of an exchange of multiple brands according to an embodiment of the present invention.

FIG. 10 shows an example of an overview of certain data aggregation processes according to an embodiment of the present invention.

FIG. 11 shows an example of a method of delivering media according to an embodiment of the present invention.

FIG. 12 shows an example of a method of delivering customer information according to an embodiment of the present invention.

FIG. 13 shows an example of a method of selling goods and services to customers according to an embodiment of the present invention.

FIG. 14 shows an example of a referral system according to certain embodiments of the present invention.

FIG. 15 shows an example of a method of social marketing according to certain embodiments of the present invention.

FIG. 16 shows an example of a social exchange stack according to one or more embodiments of the present invention

FIG. 17 shows an example of a unified identity structure of the service exchange according to one or more embodiments of the present invention.

FIG. 18 shows an example of a collective streams structure of the service exchange according to one or more embodiments of the present invention.

FIG. 19 shows an example of a collective posting structure of the service exchange according to one or more embodiments of the present invention.

FIG. 20 shows an example of a publishing structure of the service exchange according to one or more embodiments of the present invention.

FIG. 21 shows an example of a SEO structure of the service exchange according to one or more embodiments of the present invention.

FIG. 22 shows an example of an access control services structure of the service exchange according to one or more embodiments of the present invention.

FIG. 23 shows an example of a blogs structure of the service exchange according to one or more embodiments of the present invention.

FIG. 24 shows an example of a CRM structure of the service exchange according to one or more embodiments of the present invention.

FIG. 25 shows an example of a commerce structure of the service exchange according to one or more embodiments of the present invention.

FIG. 26 shows an example of an application that is enabled by the Socxs platform according to one or more embodiments of the present invention.

FIG. 27 shows an example of a system for allowing exchanges according to one or more embodiments of the present invention.

FIG. 28 shows an example of an exchange according to one or more embodiments of the present invention.

### DETAILED DESCRIPTION

The term “SOCXS” (or “Socxs”) as used herein is a brand name for one or more embodiments of the present invention and, as also used herein, can refer to the general overall system and capabilities of the present invention or also to individual aspects or embodiments of both the overall system or aspects of the present invention.

There are a wide variety of social networks available to users and organizations on the Internet. A social network is a network that fosters users' community interactions and information sharing. Often, there is more to these networks than conversation exchanges. In addition, there are a wide variety of platforms for each of these social networks. Social networking websites are becoming increasingly popular. Examples of social networking platforms include Face-book, Twitter, YouTube, Flickr, Picasa, Digg, RSS, Blogs, Reddit, LinkedIn, Wikipedia, MySpace, iPhone, Android, etc. Furthermore, social networks can include any other webpage, application, or any other platform on the Internet that is used by any organization or user to communicate to its users.

According to some embodiments of the present invention, systems and methods are presented that aggregate and publish content of an organization or user across a wide variety of social networking platforms. According to other embodiments of the present invention customer management, targeted marketing, and enterprise operations systems and methods relating to the media aggregation and publication systems, including Socxs systems are provided.

The following term descriptions are illustrative and may apply in certain embodiments of Socxs system examples described in this application or claimed.

Social Exchange: A place (or network) where social media from across disparate social networks are exchanged and aggregated. The Social Exchange System essentially brings social media, users, and social networks together for any subject matter.

Module or Widget: A module or widget is a component of a page.

Channel: various embodiments of the present invention (which may include pages, functionalities, the like, and other embodiments mot specifically disclosed herein) may be available via different ‘channels’. These channels can comprise, for example:
Web: Available on any web browser
App: Available as apps on devices, such as iPhone, Android, TV, book, readers, gaming system, Blackberry, and any other third party devices on the market today and not yet on the market.
Mobile: Available on web browsers of mobile devices
Facebook: Added to Facebook
Widgets: Embedded as web widgets anywhere
   It should be noted that this list of examples is merely illustrative and other channels may exist.

Aspects of the present invention comprise a novel Social Exchange System that enables social media for any subject matter to be exchanged easily across social networks for all users.

Embodiments of the present inventions can comprise a platform that brings together social, mobile, web and data, all in one place. In some examples embodiments can provide a continuous feed of any public information and the ability to publish to any websites, devices, and channels simultaneously.

Companies of all sizes face the complexity of social media and customer engagement that is completely fragmented and siloed. Platforms and media continue to proliferate. Staying relevant while keeping up with technology is challenging and expensive. Today's environment is dozens and dozens of moving parts.

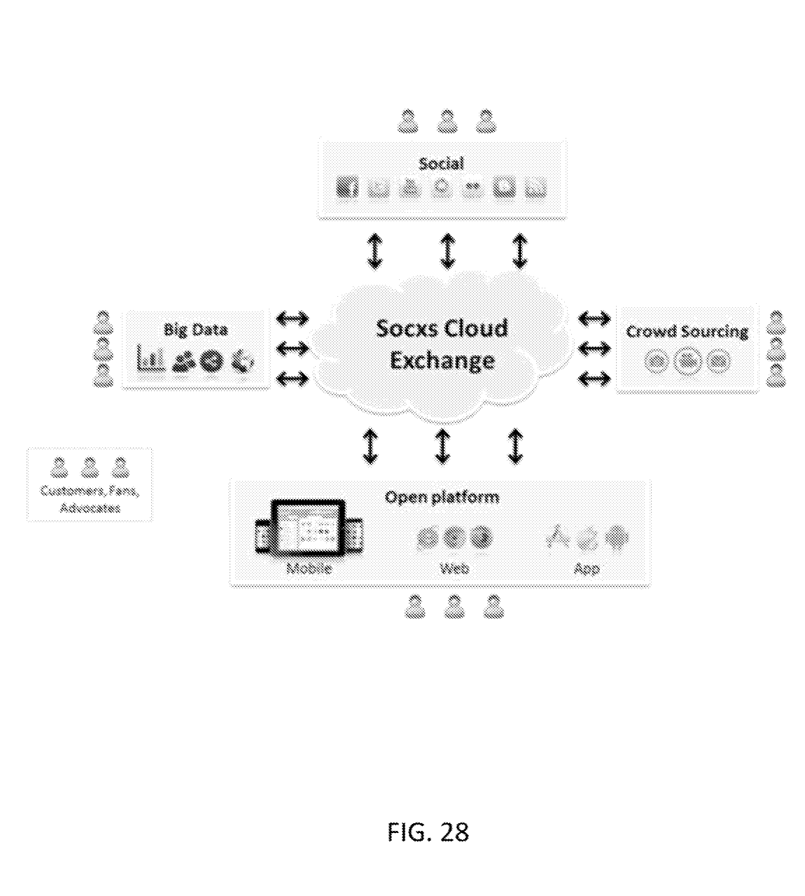

As shown in the example illustrated in FIG. 28, certain embodiments of the present invention may comprise an exchange in which one or more of data, social, open platforms, and crowd sourcing can be combined. As seen in FIG. 28, open platforms can comprise, for example, mobile based platforms, web based platforms, apps, and the like. Social platforms can comprise, for example, Facebook, Twitter, YouTube, Picasso, Flickr, RSS feeds, and the like.

An exchange according to embodiments of the present invention can help create a fully immersive brand experience—across the entire digital spectrum, such as, for example, web, social, mobile, devices, cloud, etc. Such exchanges can create a completely customizable brand presence. For example, exemplary exchanges can integrate social media from all the social networks; create a multi-threaded media streams combining any permutations of user streams from the different social networks; create real time streams dynamically with up-to-date feeds of all the streams upon every load of the brand presence; enable a create-one-brand-presence that can be published to any Channels: web, social networks, mobile, devices, and any Channel; make every module into Social Pod instantly that can be extended to any external sites (partners, affiliates, media, etc.); enable a two way user crowd sourcing, i.e. brings in media from the crowd and at the same time allows the crowd to post back, all without leaving the brand presence; create brand relevancy; and automatically optimizes tor Search Engine.

One or more embodiments of the present invention enable brands to drive target campaigns across any social networks, using any media to reach the customers; enable brands to capture the relationships of the customers to the brands across all the Channels, whether web, apps, mobile, social networks, widgets, devices, etc.; enable commerce to be part of the campaign so that brands can promote and sell to customers across any Channels; enable brands to use friends of customers to promote and convert users to customers; capture all the activities in a Big Data framework that combines all the Data Layers from the different Channels, partners, web, social networks, devices, customer, along with every interaction; allows brands to understand patterns, behaviors, trends and analysis of all these various Data Layers; and allow new apps, such as, for example commerce apps, campaign apps, charitable apps, etc., to be added to the Application Exchange.

Aspects of the present invention are illustrated by the following examples of non-limiting embodiments of the invention. The invention can, without limitation, comprise aspects of methods, software, hardware, media networks, internet use, and user input. In some examples a system such as a Socxs system described below can comprise software or software services operated on a server and accessed by users either directly or via the internet. In some examples a user can use Socxs systems and software to create a LiveEvent or Supersite or other Socxs account that can be hosted privately, by an enterprise, or by a Socxs provider, including a service hosted on the cloud. In some embodiments a Socxs user can, by the use of the Socxs account; identify, aggregate, customize, filter and publish data, media, systems and other information over public or private networks. In some embodiments enterprises can sponsor, host, or monitor LiveEvent or supersites in conjunction with marketing, advertising, customer management, public relations or other enterprise interests or activities.

According to one or more embodiments of the present invention, an exchange, such as, for example, a Socxs exchange, can create a live repository, which is a Social Destination page in some embodiments termed a LiveEvent (as well as termed a Supersite in other embodiments), which comprises a group (or an entirety) of selected social exchanges for a subject matter.

A user (basically anyone) will be able to contribute media to any LiveEvent, thereby effectively creating a Live Stream of a subject matter that is simultaneously being: pushed out to various social networks, and pulled into the Socxs LiveEvent Channel. Such a system provides a Social CMS (Social Content Management System). A dashboard, called MediaGate, to allow anyone (even non-technical users) to create their Social Destination page—the LiveEvents—on the various Channels described above. In a few steps using simple user interface, users will be able to manage their social media and users for any subject matter all in one convenient location. Users can fully customize their page without doing any software programming.

Users can specify a ‘collective streams’, which become a base collection of streams. The streams can be any type of stream mentioned herein or otherwise. The exchange can aggregate streams automatically based on the collective streams. The exchange can also manage authentication collectively across users' aggregated streams to all their social networks.

Then the exchange can pull social content as ‘streams’ from social networks into modules that can he displayed on the Channels. Each Channel can have any number of these modules. Each module can have any number of streams. Each module can have a combination of different streams from different social networks, based on the type of content.

Next, an exchange can enable users to post back to the collective streams across the many social networks from one place. In addition, the system can adds a special tag, such as for example, a Socxs tag, to each piece of media to enable the system to easily discover the media across the various social networks.

Furthermore, the system can track the collective social activities from across the many streams in the many social networks all into one convenient location. Social activities can comprise stats such as number of posts, comments, messages, file uploads, etc.

Examples of how to lookup a stream can include, according to one or more embodiments: a user specifying only the URL and the system automatically finds the stream and adds it; a bookmarklet enabling the discovering and adding of streams into the system in real time while browsing on the social networks; and/or entering a keyword or list of keywords and the system finds the streams on the social networks based on these keywords.

Also, exchanges according to embodiments of the present invention can be customizable. For example, users can fully customize their page—layout, colors, skins, and content. Users may be able to create non-social content module. This can be text, html, graphs, flash or any other type of content. Users can also create a social media module social media such as You Tube embed videos and LinkedIn relationships from other sites or services that only provide limited access to information. In addition, a module can be a combination of social media and non-social media components. In some examples, a user only has to point click, drag and drop to add/delete modules and change module placement, layout, and/or size.

In addition, the skins of a site can be modified. For example, the system may comprise a UI to change the page and module colors and/or upload to add background image. The system may also comprise a templating system that allows more advanced users to specify data structure, content type, and/or styles tor each module.

Next, users can publish data, streams, etc. For example, customized page (such as, for example, Socxs LiveEvents) can be pushed out for public viewing. In some examples, there a user can simply point and click to publish it out. In addition, a user can preview changes. Changes that are made are not available for public viewing (only as private) until the user clicks on the publish button. This allows changes to be reviewed before they are pushed out. In addition, the entire LiveEvent can be turned on and off for public and private viewing respectively. When the public is turned off, it can be effectively a private site for internal use. In some examples, a private site requires login access.

Furthermore, each Socxs LiveEvent can be optimized so it's easy for search engines to crawl and index. Search engine optimization is discussed in more detail later.

Embodiments presented herein also can provide options such as, for example, schedule posts; schedule publishing; alert users when specified triggers are activated, such as, for example, by traffic, by keywords, by events, etc. A user can also monitor the buzz/sentiment about a brand, product, interest, etc. based on specified parameters. Filters on streams based on provided keywords can also be provided. In addition, any of the above elements can be combined together. For example, a user can combine the above workflow elements to create more sophisticated business rules, such as a ‘monitor’ with an ‘alert’.

The systems and methods presented herein also allow for a unified user profile. This allows a user to be Identified, and mapped across various social networks. For example, if he's ‘Kratos’ at Google, Socxs can map him to ‘John Smith’ on Facebook, ‘ilikegames’ on Twitter, etc, building out a Unified User Profile for that particular user.

Furthermore, systems and methods presented herein allow an aggregation of searches and their results across all social networks, publicly available content, and search engines. For example, Socxs technology provides the functionality to do a Socxs Search. A user enters the keywords to search/filter terms used by the Socxs Search. The Socxs technology enables the keyword search across all the different social networks and predefined relevant publically available data. The Socxs technology then aggregates the search results. The MediaGate technology publishes back a page dynamically with the aggregated results of the search.

Aspects of embodiments of the present invention can also include media connections, Socxs ‘Media Connections’ is a page, built dynamically from the relationships in Facebook Social Graph. A user could simply enter a Facebook page of interest and Socxs will create an aggregated page based on the relationships in the Facebook Social Graph. The Socxs technology will read a Facebook Social Graph and give the user a full representation of what the page will contain in terms of content, media, and with the modules Hilly aggregated. Socxs technology automatically builds a page that aggregates the content from all the sources within the Facebook Social Graph relationships.

It should be noted that the systems and methods presented herein allow for a combination of any number of modules/pages. For example, a user can create a page using any number of customized pages and modules; Socxs Search Aggregation; Socxs Social Graph Pages; and the like.

Furthermore, according to aspects of embodiments of the present invention, pages can be created that allow a unified presence on the web, mobile devices, and the like. In some examples, this can be done automatically, with no input from the user necessary. It's basically a fully customized mobile version of the Socxs frontend page that is automatically generated with no extra work. It will be accessible from browser app of mobile devices. Applications can be developed, to be downloaded onto iPhones, Android and other smart phones which enable mobile application to be accessed directly from an icon on a phone. These applications would launch Socxs pages. The system may be able to auto detect the phone mobile browser and display the mobile version instead of the regular version. In some examples, one module may be displayed at a time on a mobile device. It should be noted that more than one module may also be displayed. Furthermore, the size of the module can be optimized to fit into the mobile screen.

In embodiments of the present invention, pages and modules can be shared easily. The Socxs system can. automatically adds the sharing functionality to every Socxs page and module. All visitors to the Socxs page can share the content. For example, even if they don't have MediaGate access to the page, they can still share the page content. Generally speaking, if the page is public, the page content can be shared.

Furthermore, systems and methods described, herein can also capture the data and statistics when users share content. For example, the following can be tracked:
Who is the user?
What did the user share?
What are the Source and Destination pages?
How many times the user shared the Socxs content?

In addition, the systems and methods comprised herein can automatically create code for every module on the page. When visitors embed, this code into their own website, it'll automatically recreate the module. This module is updated with live data every time the page is refreshed. This code is made available to visitors on a Socxs page and on each embedded module. The modules embedded into a non-Socxs domain are still fully functional and interactive as it would be on the Socxs page.

Many different types of modules can be created. For example: Media (Video/Audio) Stream type; Rating and Review module type; Polling and Survey module type; Sweepstakes module type; Registration module type; Social Graph module type; and a Socxs Social and Viral CRM (a module type that enables capturing of CRM information about the user, profile, demographic, geographic, promotions, etc.) Many other module types can also be created.

Furthermore, modules can also be shared. Socxs technology allows users to share any new module type created by users, adding to a library of user created modules. This library can be available resource of user created modules that everyone can grab and use hi their Socxs pages.

As shown above, examples of the present, invention allow: Consistent Brand and Social Experience; Social & Viral CRM Campaigns; Social Direct Marketing; Social Promotions; Social Coupon Marketing; Social Pyramid Marketing; Social Sweepstakes; Cross Social Network Applications; Click Campaigns; and Live, Viral & Relevant Marketing: Anyone-to-Anything-to-Anywhere.

According to one or more embodiments of the present invention, a user will be able to aggregate and create a LiveEvent based on his or his company's subjects of interest. Socxs enables the campaign manager to cross promote across any number of these social media, market to the users selectively in the social networks most appropriate for the users. The campaign manager can create a LiveEvent whereby there users and fans can further take his media to any websites. The manager will have a LiveEvent whereby all interested parties, whereby internal or external to his company—such as employees, customers, and the public—can share their experience and media. The stats from all the social networks are tracked within a unified Socxs framework so that the campaign manager will be able to further analyze the stats data for trends and results.

According to one or more embodiments of the present invention, a user will be able to run campaigns. For example, the systems and methods of the present invention will allow:

Delivery: It's a platform to deliver campaigns for loyalty, branding, marketing, products, PR, promotion, etc

Customization: Create targeted campaigns to the users based on their provided information in the Unified User Profile.

Outbound: Push out social campaigns to any number of social networks.

Inbound: Aggregate the social streams back into a page to promote the company, brand, product, campaigns, etc. Aggregate social streams back to monitor activity, gain understanding, from a customized perspective.

Widgets: Port any of the LiveEvents contained in a channel anywhere . . . but they are still centrally managed and tracked.

User Demographic: Create media that are surveys to better understand the users across the various social networks.

Viral: Easily start viral marketing using Socxs Channels across the various social networks.

Events: A system for running campaigns for events where time is critical and relevant for only a short period, such a political campaigns, tradeshows, festivals, product introductions, etc
The system, enables creation of Social Sites in real time that contains information and social content.
It also brings together the community of users for the event.
It's the one place where the users can see all share, and exchange information about-the event.

Furthermore, according to embodiments of the present invention, systems and methods allow for social apps and gaming. The system comprises an infrastructure for building Social Apps and Games. The social apps and games built on the infrastructure according to embodiments of the present invention engages users across not just Facebook, but also users across the Socxs Network; an Enterprise Network base; and other social networks, such as Twitter, YouTube, etc.

An overview of an example of a Socxs social exchange system is shown in FIG. 6. FIG. 6 shows a series of exemplary Socxs members (or users), with three members specifically shown in the figure and represented in respective vertical columns. Represented in horizontal rows (or layers) are exemplary social networks such as Facebook or Twitter. Also shown is a horizontal row for a Socxs network which may have similarities or differences in capabilities from those of the pre-existing or future social networks shown. Also shown is a horizontal block representing “channels”. FIG. 6 includes a reference Legend as shown.

The example of the embodiment shown in FIG. 6 enables the following effects. One outbound media How action changes all the layers, or in other words one media flow action can publish into all the layers (that have been selected automatically or by customization for the Supersite or the particular user). One Socxs dashboard can see all inbound media flow and enable the user or operator to respond. In some instances a user direct response is of course not needed as the Socxs system can be configured to operate or respond automatically and/or according to rules. The rules may be custom defined or default according to a variety of factors such as particular social network, identity of members, characteristics of members, characteristics of inbound or outbound media, timing of inbound media, traffic “density” or activity of certain social networks, groups. Importantly, the Socxs system can also apply rules to inbound or outbound media flow based on factors beyond the above factors. For example, the Socxs system can apply roles wherein inbound or outbound media flow is based on what is termed “outside factors”. In some cases the outside factors are events or characteristics not particularly unique to the member or social network characteristics. Examples of such outside factors include thresholds or changes in factors such as weather, cataclysm, sports event developments, financial, market developments, political news, or other factor. The nature, degree, relevance (including to particular members or social networks) of the outside factors can be automatically applied via rules to filter, decelerate, accelerate, highlight or otherwise affect inbound or outbound media flow.

In the example of FIG. 6 the Socxs system provides collective metadata integration across network metadata, designs to provide an exchangeable structure that can be valuably shared among Socxs members (users) including shared into Supersites and targeted social networks (e.g., for facilitation of outbound media flow.)

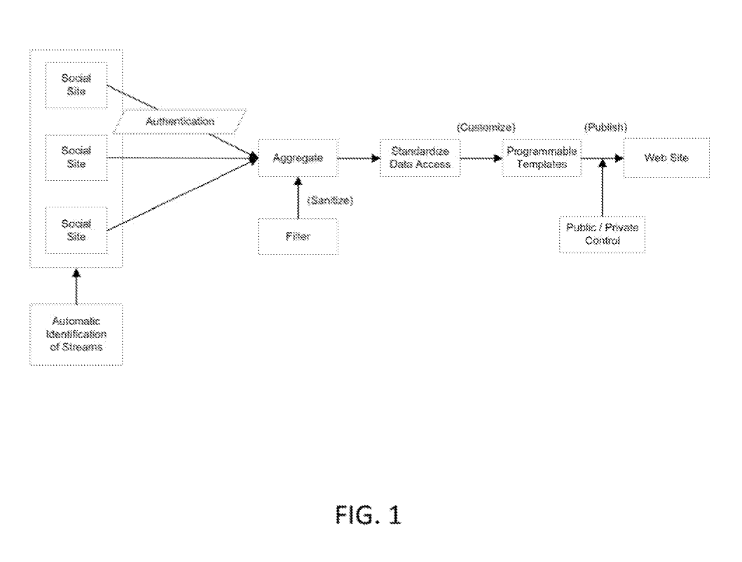

FIG. 1 shows aspects of an example of a method of aggregating and publishing media according to certain embodiments of the present invention. This method is merely exemplary and is not limited to the embodiments presented herein. This method can be employed in many different embodiments or examples not specifically depicted or described herein.

Shown in FIG. 1 are one or more exemplary social sites, an authentication, step, procedure or process, an aggregation step, procedure or process, including a filtering option, a data standardization step, procedure or process, customization steps, procedures or processes, implementation of various levels of public, private or other controls, and publication, steps, procedures or processes of various types. These general steps, procedures and processes are described, in greater detail below, including the citation to various exemplary embodiments of various aspects of the invention.

The method of FIG. 1 includes a procedure of Identification of Streams, which in some embodiments can be an Automatic Identification of Streams. In this embodiment the Socxs system will automatically identify the internet accessible “Streams” that Socxs can process and integrate. This feature and capability greatly simplifies the integration of Social Media tor the non-technical user. The explanation below exemplifies the capabilities of an embodiment of the Socxs system for an exemplary “user” of Socxs to, among other things, identity source streams, authenticate, aggregate and eventually publish data from the stream or otherwise provided by the user or other parties as shown in FIG. 1.

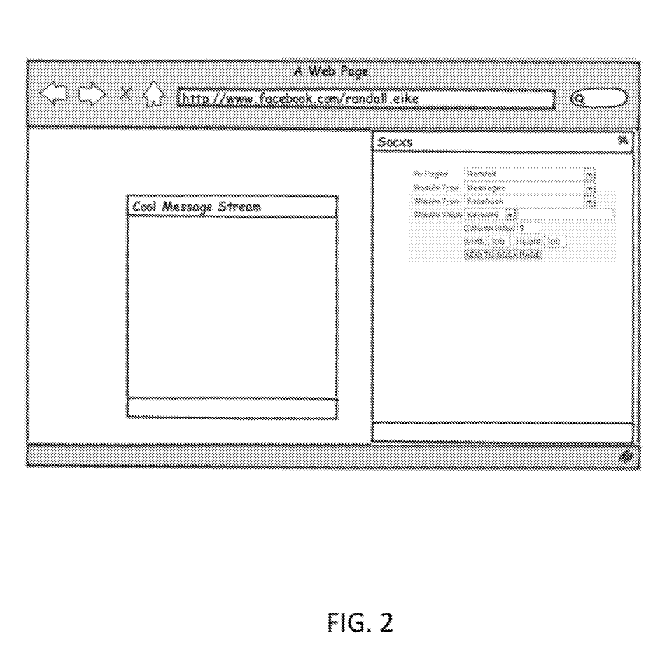

In some embodiments the following capability is provided at the beginning of the process shown in FIG. 1. As an example, if a user is browsing the web and finds a page on a Social Network with some interesting conversation or content (or other content that the user would like to use or publish), the user can simply click on. the Socxs system's Bookmarklet and a “Socxs” module appears in the right gutter. This can be seen in the example depicted in FIG. 2, which is an example from an embodiment of the present invention.

After identification or selection of the Social Network, a Socxs module will access the identified or selected URL and identify the “streams” from the URL that the Socxs system will or can process and integrate. This greatly simplifies the integration of social media for non-technical users of the Socxs system. Socxs can automatically identify the information necessary for Socxs to pull the Stream into Media Gate (described below) and even add it to a module on a page all in one action. A module is an area on a page that reflects content from one or more networking platforms.

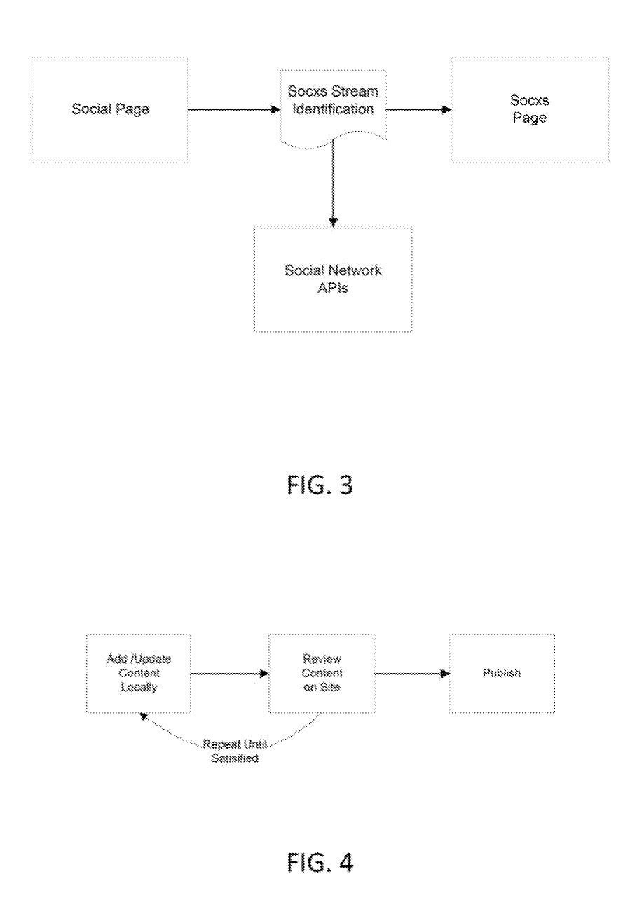

With reference to FIG. 3 (an example from an embodiment of the present invention), the Socxs Stream Identification system pulls information from the page and understands how to map that information to and/or from the Social Network's APIs. In some embodiments each Social Network that selected by a Socxs user may be integrated into the Automatic Id lookup. The system looks for specific known patterns in the URL and page. When the system finds the patterns, it maps them to Stream types the system supports and the logic the system needs to pull the data from the backend APIs. The system presents them to the user to select which “Stream” the user may want to include.

Next, the method of FIG. 1 includes a procedure of Authenticating. During the Authenticating procedure, the system collects and manages multiple “Authentications” for users and uses that to retrieve content from the Social Sites.

Subsequently, the method of FIG. 1 includes a procedure of Aggregating. Aggregating includes pulling content on demand for use from a site, which can be public or non-public.

Then the method of FIG. 1 includes a procedure of Sanitization. The system offers the ability for owners to review and Filter content, i.e., approve/reject it before (or after) pushing to the site. This procedure can be an optional one.

Next, the method of FIG. 1 includes a procedure of Standardizing. During standardization, the system pulls content from disparate networks with disparate APIs, formats, and data and puts them into a standardized set of “Steam” types. As an example, this enables the user to quickly and easily integrate Flickr, Picasa, and Face-book photos feeds, even though their backend APIs are totally different and return different attributes.

Furthermore, the method of FIG. 1 comprises a procedure of Customizing. During customization, the standardized data sets are then available to the Socxs Programmable Template Scripting engine which. Generally, this is a scripting language that allows the user to layout her selected content in a whatever fashion she may elect or desire. They can provide better and more interesting user interfaces for the content and seamlessly integrate it into their site.

In addition, the method of FIG. 1 includes a procedure of Public/Private Control. The system offers the user a line tune control about what content is to be displayed. As an example, a user can set the level of control to personal, organization only, or public. It should be noted that more or less levels of control can be used.

Next, the method of FIG. 1 includes a procedure of Publishing. The system pushes the output to a public facing web site.

In other embodiments, a method and system tor improving web content management with automatic file synchronization is presented. This method and system is merely exemplary and is not limited to the embodiments presented herein. This method and system can be employed in many different embodiments or examples not specifically depicted or described herein.

In this method, a user can download a client program that runs locally which sets up a shared folder between the user's computer and the user's Socxs account Whenever a user creates a freeform module, the program creates a corresponding folder on the user's computer in his or her SOCXs folder. Then the user can simply edit files in their local folder and they get automatically synced with the Socxs module. Users can use their regular web tools and see their changes reflected on the site almost as soon as they click save. The user doesn't have to worry about zipping up files and uploading them into MediaGate. Likewise for background images, it is much more convenient to drag an image to a folder than to have to upload it into MediaGate, And for images in some embodiments, the Socxs system applies .rules to automatically generate different web read sized images from the original.

FIG. 4 depicts an example of the workflow of the system. This system and method are more efficient from previous systems. As an example, the system saves time because content is already on the contributor's local computer (i.e. don't have to wait if large files are involved), eliminates file version issues (where someone would overwrite someone else's change because they didn't download all changes), and simplifies the process (no need to “login” to a CMS system.)

Additional components of this system can include, for example: subscribing to web site sections and only those sections are synchronized to a user's local drive, notification system (if someone changes files in a section in which a user is subscribed, the user gets a notification), automatically generate “web ready” assets from assets uploaded (based on users configured profiles—as examples, thumbnails and multiple sizes images from the original and encode video to various codec/bitrates for web delivery and select key frames for a thumbnail), and more fine tuned auditing information (for example, it is easy to track and remember every version of every file that is changed.)

In addition, a method and system of stream retrieval and caching is presented. As an example, this can be a system and method for determining when a particular module should be populated with new data, or whether the current data is good enough to display in the module. This method and system is merely exemplary and is not limited to the embodiments presented herein. This method and system can be employed In many different embodiments or examples not specifically depicted or described herein.

Embodiments of the present invention may comprise all or only portions of the steps or methods described in the exemplary descriptions above.

The following example illustrates a users experience according to one embodiment of the present invention. A user will sign up for a social exchange page, such as, for example, a Socxs page, which can be called a Socxs LiveEvent. The user sets up his LiveEvent for a Subject using Socxs Dashboard, via the following process. He established links and authenticates with Social Networks. As an example, he chose to authenticate with Facebook, Twitter, YouTube, Flickr, Picasa, MySpace, LinkedIn, Blogs, Digg, RSS, Socxs proprietary, and more. Using Socxs, he proceeds to discover the streams he wants to add to his LiveEvent. This can be accomplished using a Socxs Stream Discoverer (Stream Lookup) feature. The user will discover and add his ‘Collective Streams’ for his LiveEvent using Socxs Dashboard, He can add filters based, keywords, dates, names, favorites to drill down his collective streams.

Next the user can proceed to customize his page (or LiveEvent). For example, he can alter the layout, skins, messaging, and content using Socxs Dashboard.

Then Socxs will pull the media for John's collectively stream dynamically. The user will then be able to post outbound media to all the social networks and Socxs. If the user completes one outbound media action the system dynamically changes all the layers (all the social networks and Socxs). Socxs can then publish the user's LiveEvent automatically into the Channels.

Socxs can automatically track the collective social activities from across the many streams in the man social networks all into one convenient Socxs Dashboard. (Social activities can comprise stats such as number of posts, comments, messages, media exchange, file uploads, etc.) In addition, Socxs can add a special Socxs tag to each piece of media to enable the system to discover the media across the various social networks.

Furthermore, the user will also be able to schedule his posts and publishes into his LiveEvent. He can create alerts to hint when certain triggers are activated (by traffic, keywords, and/or events). And he can monitor the buzz/sentiment about a brand, product, interest, subject, etc. based on specific parameters.

The following example can illustrate a “fan “experience in an exemplary embodiment according to aspects of the present invention. Fans can be considered anyone that is not the user, who is interested in the user and/or the subject matter of the LiveEvent. Fans can post media to the user's LiveEvent and it can appear in ail these places, for example:

a) All the social networks in the user's Collective Streams

b) the user's Socxs LiveEvent

c) The Fans' own social network pages.

In additional embodiments of the present invention and in relation to the above examples, when there is another Socxs LiveEvent, say it's set up by user ‘Jane’, Jane's LiveEvent will be able to have media exchanges with the original user's LiveEvent. Each exchange will add social value, coverage, and distribution. (This is the exchanges shown by the arrows marked with ‘X’ with respect to FIG. 6) Also, with each exchange, Socxs can provide a unified user profile which can will identify each user and continually map each user across the social networks to create a Unified User Profile, Example, John could be ‘Doe’ on Facebook, ‘BigMan’ on Twitter, and ‘GoGetter’ on Google.

The following example sets out specifications for certain aspects of a particular embodiment of a Socxs implementation. This example comprises the following sections: Core Media Gate Features, Automatic Identification of Streams, Web Content Management via File Synchronization, and Stream Retrieval and Caching

Automatic identification of Streams—Basically, given a URL Socxs may automatically identify the “Streams” that Socxs can process and integrate. This greatly simplifies the integration of Social Media for the non-technical user.

Authenticate—collect and manage multiple “Authentications” for users and use that to retrieve content from the Social Sites.

Aggregate—pull content on demand for use on public site.

Sanitize Socxs can offer the ability to for owners to review and Filter content—approve/reject it before (or after) pushing to the site.

Standardize—Socxs can pull content from disparate networks with disparate APIs, formats, and data and put them into a standardized set of “Stream” types. This enables the user to quickly easily integrate Flickr, Picasa, and Facebook photos feeds, for example, even though their backend APIs are totally different and return different attributes.

Customize—these standardized data sets are then available to the Socxs Programmable Template Scripting engine. This may comprise scripting language that lets the user layout their content in whatever fashion they desire. They can provide better and more interesting user interfaces for the content and seamlessly Integrate it into their site.

Public/Private Control—offer fine tune control about what content, is personal, organization only, or public.

Publish—push the out to a public facing web site.

The automatic identification of Streams module may access the URL and the content of the page and automatically identify the information necessary for Socxs to pull the Stream into Media Gate and even add it to a module on a page all in one action.

With reference to FIG. 3, the following is an example of an implementation of a Socxs Stream Identification, system, according to aspects of the invention. The system pulls information from the page and understands how to map that information to the Social Network's APIs. Each Social Network, that is integrated, has to be integrated into the Automatic Id lookup. The Socxs system can. look for specific known patterns in the URL and page. When Socxs finds the patterns, it can map them to Stream types it supports and the logic needed to pull the data from the backend APIs. They are presented to the user to select which the “Stream” they want to include.

The following example illustrates an enhanced MediaGate implementation according to examples of various embodiments of the present Invention. In MediaGate, a user can download a client program that runs locally which sets up a shared folder between the user computer and the user's Socxs account. Whenever you (the user) create a Free-form module, the program creates a corresponding folder on your computer in your SOCXs folder. Then the user can simply edit files in their local folder and they get automatically synced with the SOCXs module. Users can use their regular web tools (e.g. Dreamweaver) and see their changes reflected on the site almost as soon as they click save. They don't have to worry about zipping up files and uploading them into MediaGate. Likewise for background images, it is way more convenient to drag an image to a folder than to have to upload it into MediaGate. And for images we could also put rules in place automatically generate different web read sized images from the original.

As another example, the following can be a set of guidelines that are used to help determine whether the system should wait for new data to be displayed in a module, or whether the current data in cache is good enough to be displayed in a module.

1. Always populate a module with “something”; a module should never be empty.

a. It is better to show old data than no data.

2. Always deliver the page to the user in a timely fashion; such as, for example, less than 5 seconds. It should be noted that any other period of time can be used.

a. As an example, for 5 seconds, never wait more than a total of 4.5 seconds for an external call to complete. It should be noted that any period of time can be used here also.

3. If it we can't deliver up to date data for a given request, still attempt to have that data available for future request.
4. Be robust in the face of failure to pull data:

a. Don't constantly retry over and over, but also don't give up trying to get failed data in a reasonable period. Strike a balance.

b. When it fails, continue to deliver the stale data.

5. Have the ability communicate to the end user

a. The timeliness of the data that we do present to them.

b. Errors in pulling data when they do occur.

6. Don't over-pull data. If one request is causing a stream to be pulled, another request should invoke the same external requests but rather should piggy back on the original request.

Furthermore, the following are examples of relative states of cached data:

1. Current—the data in the cache is considered current and we simply return it to the user.
2. Semi-Stale—the data is fresh enough to immediately return to the user, but we should refresh the cache of data we have.
3. Stale—the data is out of date, we should attempt to get fresh data for the user.

It should be noted that more or less freshness states can be used. In addition, different freshness states of data can be used.

In addition, data can have error states. The following are examples of error states:

1. No-Error—everything is smooth; no problem
2. Refresh-Timeout—the last attempt to refresh the data, timed out
3. Refresh-Failed-External—the last attempt to refresh the data resulted in the external provider returning a service error (i.e. they did not send valid data)
4. Refresh-Failed-Internal—the last attempt to refresh the data resulted in an error processing the returned data

It should be noted that more or less error states can be used. In addition, different error states of cache can be used.

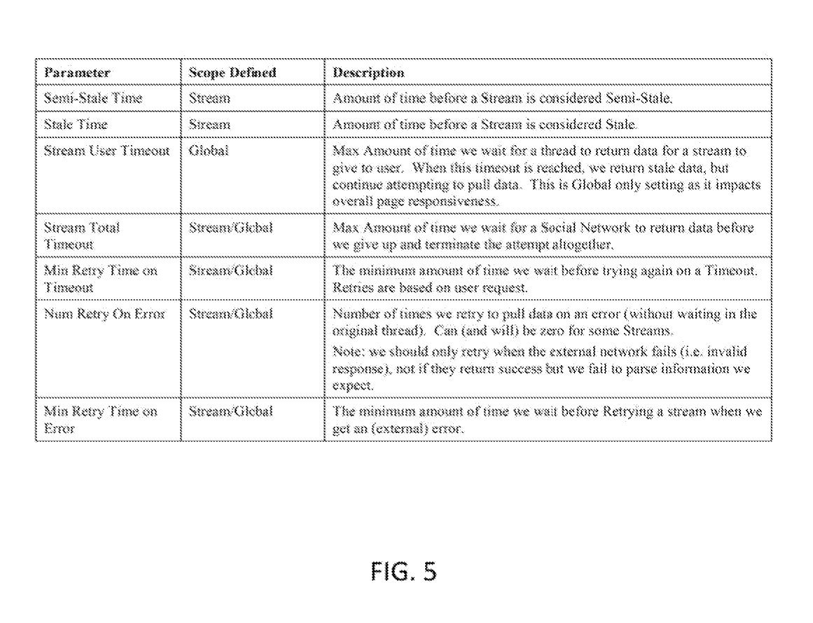

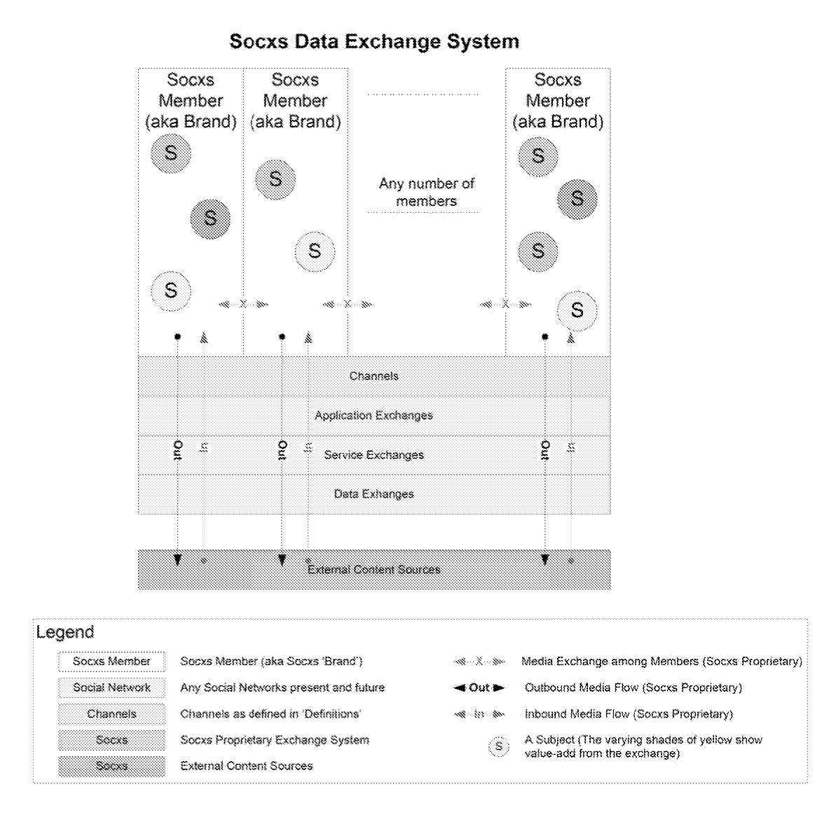

FIG. 5 depicts examples of parameters that are relevant to the data caching System. It should be noted that more, less, and/or different parameters can be used.

Also presented is a method for using the system and method of aggregating media. This method is merely exemplary and is not limited to the embodiments presented herein. This method can be employed in many different embodiments or examples not specifically depicted or described herein.

The following are examples of the capabilities of the method and system of aggregating media (Socxs).

Centralized Management: Socxs provides a single dashboard, called MediaGate, to allow non-technical users to manage their social content, social users, and social campaigns all in one convenient location using simple user interface. In addition, the system can allow that there is a hierarchy of users. In one example, there are different permission levels to limit user access (read and/or modify) to pages.

Aggregation: Socxs provides an ability to aggregate data from a variety of different platforms. As an example, you can have collective streams. A user can specify her ‘collective streams’, which become the base collection of streams. This allows the system to authenticate, pull, post, and track.

In addition, Socxs can authenticate users. As an example, Socxs can manage authentication collectively across a user's aggregated streams to all the user's social networks.

Furthermore, Socxs can pull data. As an example, the system can pull social content as ‘streams’ from social networks into modules in social web pages. Each social web page can have any number of these modules. Each module can have any number of streams. Each module can have a combination of different streams from different social networks, based on the type of content

Furthermore, Socxs can enable posting of data. As an example, the system allows a user to post back to the collective streams across the many social networks from one place.

In addition, Socxs can enable tracking of data. Similarly, the system tracks the collective social activities from across the many streams in the many social networks all into one convenient location. Social activities are stats such as number of posts, comments, messages, file uploads, etc.

Also, Socxs allows a user to manage streams. As examples, a user can manage streams by URL, that is the system provides a simple method to add streams into the system. The user specifies only the URL and it is added to the system. In addition, a use can manage stream by bookmarklet. A bookmarklet enables a user to add streams into the system in real time while browsing on the social network pages.

Customization: Socxs provides a user with the ability to customize her page. As an example, a user can customize a webpage (its layout, skins, content, etc.) In one embodiment, Socxs allows a user to create non-social content modules. In the same or other embodiments, users can point, click, drag, and drop to add/delete modules and change module placement (e.g., move, span, and/or adjust size.) In yet other embodiments, with Socxs a user can used a simple UI to change the page and module colors and a simple upload to add background image. Furthermore, in more embodiments, Socxs can contain a unique templating system that allows more advanced users to specify data structure, content type, and styles for each module.

Republish: Socxs allows a user to republish data from networking platforms. As one example, Socxs provides a customized social website tor public viewing. In another example, a simple UI can be used to point and click to publish the data. In yet more examples, users are allowed to preview changes. In one embodiment, changes that are made to a webpage are not available for public viewing until the user clicks on the publish button.

In some embodiments, there are different privacy levels that can be set for each page, or even module. In one example, there is a flag to turn a page or module on or off from being public. In some embodiments, the private setting requires login access.

Furthermore, in some embodiments, Socxs allows each social page to be optimized to so it is easy for search engines to crawl and index.

In some embodiments, the method of using the system and method for aggregating data can vary for the type of users. Examples of different types of users include enterprise users, small business users, and individual users. It should be noted that more, less, or different users can be included.

In one example, the user is enterprise users. Enterprise users are allowed the greatest range of access to the system. Each Enterprise Network will have its own user database that is not shared with, another enterprise network's user database. The Socxs system can be used to bridge enterprise account system with accounts on social networks to enable customized marketing campaign for the enterprise. In addition, the system can be used to integrate enterprise's own user community with the community on social networks. As a result, the user can identify and map the enterprise's users to the users across the social networks. As one example, the user can determine that one individual has a user ID of ‘Kratos’ at the company user base, and has a user ID of ‘John Smith’ on Facebook, and ‘ilikegames’ on Twitter, etc. The Socxs system is a layer above all the social networks account systems that maps and integrates users in the social networks to the enterprise's own user base.

This type of information can be used for a variety of purposes. For example:

Survey System: Add social surveys to capture user information that is customizable to the enterprise's markets and requirements.

Social User Database: The Socxs system can build a database to store user mapping and user information

User Dashboard: There is a dashboard to allow business users to create reports and queries the Social User Database.

As another example, the method of using the system and method of aggregating data can comprise a procedure of creating campaigns. As an example, campaigns can include:

Delivery: it's a platform for enterprises to deliver campaigns for loyalty, branding, marketing, products, PR, promotion, etc

Customization: Create targeted campaigns to the social users based on their provided information in the User Database.

Outbound: Push out social campaigns to any number of social networks.

Inbound: Aggregate the social chatter back into your domain fully customizable Social Sites where the enterprise can further promote the company, brand, product, campaigns, etc.

Widgets: Port any of the modules anywhere, but they are still centrally managed and tracked.

Events: A system, for running campaigns for events where time is critical and relevant for only a short period, such a political campaigns, tradeshows, festivals, product introductions, etc. The system enables creation of Social Sites in real time that contains information and social content. It also brings together the community of users for the event. It's the one place where the users can see all, share, and exchange information about the event.

As an example the enterprise can use Socxs to: schedule posts, schedule publications, alert business managers when specified triggers are activated (such as, for example, by traffic, by keywords, by events, etc.), monitor the buzz/sentiment about the brand, product, interest, etc based on specified parameters, filter out streams based on provided keywords, or combine any of the above elements to create more sophisticated business rules, such as you can set a ‘monitor’ with an ‘alert’.

In other embodiments, a user can use Socks to access mobile markets. For example, a user can bring the Social Sites as mobile sites or apps accessible from ‘mobile devices’ (such as, but not limited to iPhone, iPad, Android, etc.), convert each module into tabs that fit and are optimized for the mobile devices, and enable content managers to create content, post, and publish them, through the system from the mobile devices.

Furthermore, in other embodiments, a user can create social applications and games. The user can use the system as an infrastructure for building social apps and games. As an example, the social apps and games, built on Socxs infrastructure engages users across a variety of social platforms (i.e., not just Facebook, but also users across Socxs Network, Enterprise Network base, other social networks, such as Twitter, YouTube, etc., and mobile devices. It should be noted that any other social platform can be included.)

In addition, it should be noted that various users can use Socxs to cross promote across Socxs networks and/or enterprise networks.

In other embodiments, Socxs technology creates an aggregation of searches and their results across all social networks, publicly available content, and search engines.

As an example:

1. The Socxs technology provides the functionality to do a Socxs Search.

2. A user enters the keywords to search/filter terms used by the Socxs Search.

3. The Socxs technology enables the keyword search across all the different social networks and predefined relevant publically available data.

4. The Socxs technology then aggregates the search results.

5. The MediaGate technology publishes back a web page dynamically with the aggregated results of the search.
i. It's a new representation of search displayed in a Socxs Supersite webpage.

In other embodiments, Socxs ‘Media Connections’ page is a web page, built dynamically from the relationships in Facebook Social Graph. For example, a user can simply enter a Facebook page of interest and Socxs will create an aggregated web page based on the relationships in the Facebook Social Graph. The Socxs technology will read a Facebook Social Graph and give the user a full representation of what the page will contain in terms of content, media, and with the modules fully aggregated. As an example:

1. User enters a Facebook page

2. Socxs reads the relationships within Facebook Social Graph

3. Socxs technology automatically builds a page that aggregates the content from all the sources within the Facebook Social Graph relationships.

In other embodiments, Socxs enables pages and modules to be shared, easily. The Socxs system automatically adds the sharing functionality to every Socxs page and module. All visitors to the Socxs page can share the content. For example, even if they don't have MediaGate access to the page, they can still share the page content. Generally speaking, if the page is public, the page content can be shared.

This will enable businesses to easily start a Social, Viral, and Click Marketing campaign, enabling ‘Anyone-to-Anything-to-Anywhere’, making the campaigns ‘Live, Viral, and Relevant’ via Socxs ‘AnyAppWhere’.

Live App: The following is an example:

Objective
Create a companion app that allows users to capture and post messages, photos, and videos into their social networks and ultimately back into their Socxs pages.
Enable the app to allow users to capture as fens for organizations social streams.

What does the App do?
Access/view My Pages: user's page and other organization's pages (Live Events)
Capture/post messages, photos, and videos to both, the user's own account page and other Socxs organization's pages

Live Capture
Personal:
   This is basically the post tab
   Allowing user (account owner) to capture and post into his/her own social network or Facebook pages, just as in the Post tab.
Organization:
   Allow users, fans, and account owner (everyone) to capture and post into the organization page
   Update the userid and keyword tags automatically based on MediaGate aggregated streams
   Add a flag to allow admins to exclude/disable it from the App

App Flow
In order to make the app simple, it may be desirable to not be multiple steps and pages.
   In fact, in one example there is only I main page and that's ‘View Page’.
   And, you can switch easily between your personal and other organizations' ‘View Page’.
   The other page types are for Sign In and Sign Up.
The list of pages and flow are below:
   View Page
   Sign In/Sign Up selection
   Sign In
   Sign Up
   My Streams (Quick Add)
In order to use the app, i.e. to get to ‘View Page’ screen, users will ALWAYS need to be SIGNED IN.

Screens
Browser vs. App:
   There are 2 ways to access a Socxs page from a Smartphone:
      Browser:
         This is what we have today with ‘www.socxs.com/ . . . ’ changed to ‘m.socxs.com/ . . .’
         From the browser, users can only view the page and not capture, sign in, add streams, etc, as with the app.
      App:
         The app will -allow users to view, capture, share, add streams, etc, per the screen below
App Screens:
   My Pages:
      That is just View Page for the user's own account page and all the pages that he/she has admin access.
   Share:
      This is similar to the Post tab in MediaGate, which allows you to add messages, photos, and videos,
      Messages:
         Post to only one Facebook or Twitter stream in the aggregated list
      Capture (the camera icon):
         Select whether it's video or photo to add to the social network destination
   Live Events:
      Clicking the nav icon:
         This is just a list of events that users can post to.
         Users can also search the list.
      Selecting an Event:
         It'll launch View Page for the organization with the Share functionality for the particular organization.
   My Streams:
      This is just the Quick Add overlay fitted in the mobile screen.
   Bookmark:
      Allow you to bookmark live Event pages that you are interested in.
      Once bookmarked, the Live Event pages can be found in the menu.

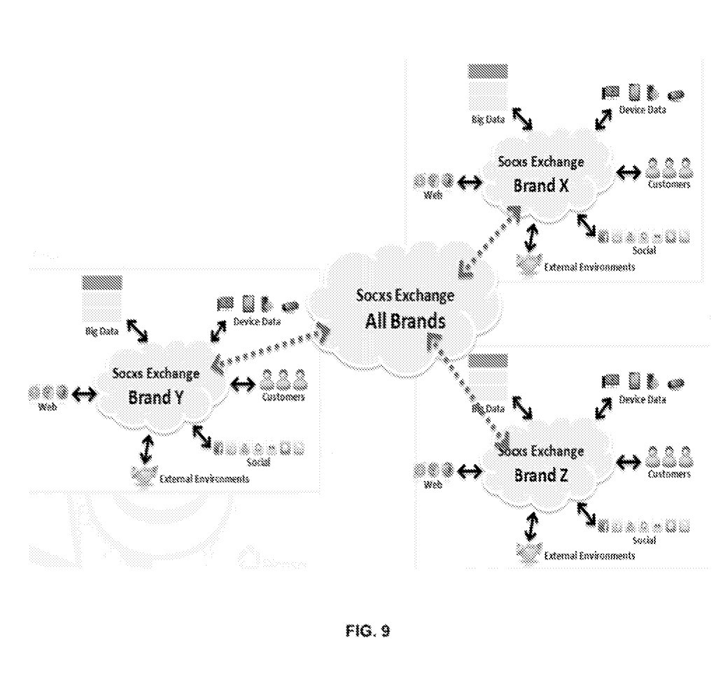

FIG. 9 shows an example of an exchange of multiple brands according to an embodiment of the present invention. According to the embodiment of FIG. 9, each brand has its own exchange. Socxs is the hierarchy of exchanges and brands can interact with each other.

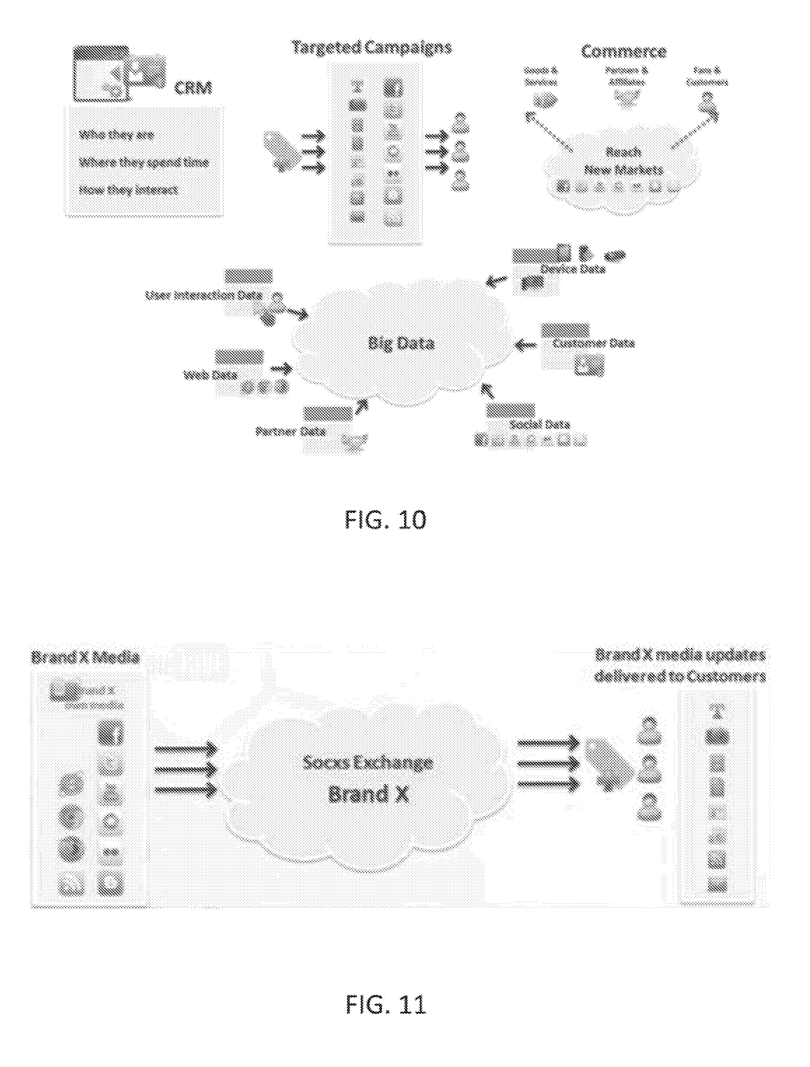

FIG. 10 shows an overview of certain data aggregation processes according to an embodiment of the present invention. In the embodiment of FIG. 10, data from multiple locations, such, as, for example, data from across the web, social networks, customers, devices, user interactions, etc. is captured. In addition, a data map of the data across the entire exchange for each brand is created so that each data set can be mapped to the others. Furthermore, the data can be analyzed for unique patterns for the brands to enable campaigns, promotions, marketing, sales, etc.

FIG. 11 shows an exemplary method of delivering media according to an embodiment of the present invention. In the embodiment of FIG. 11, users are able to tag a particular brand, the system is able to deliver brand media to the user, and in addition, the brand is able to deliver certain media to specifically targeted users.

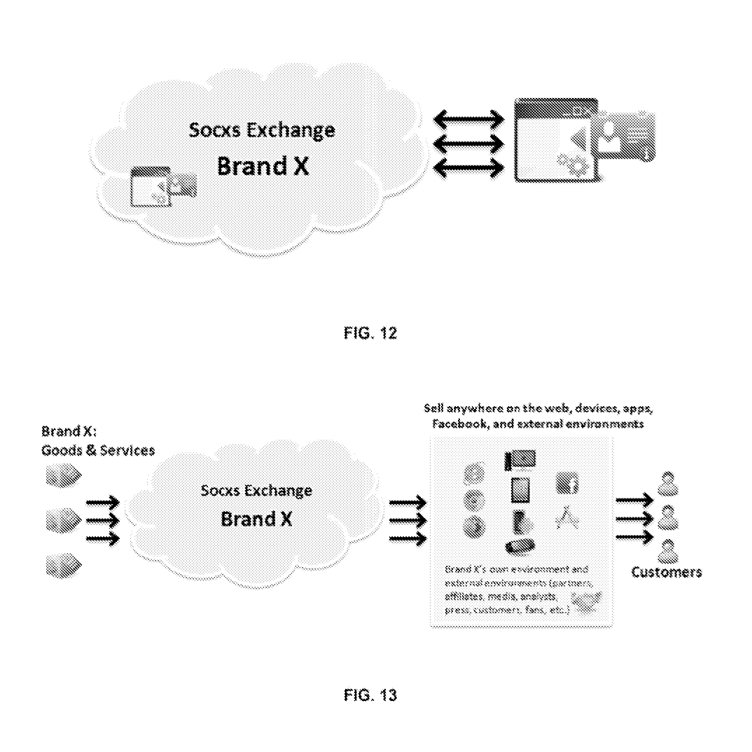

FIG. 12 shows an exemplary method of delivering customer information according to an embodiment of the present invention. In the embodiment of FIG. 12, a widget, is shown that allows the capture of user info, manipulation of user info that can be captured, and allows knowledge of how user behavior.

FIG. 13 shows an exemplary method of selling goods and services to customers according to an embodiment of the present invention. In the embodiment of FIG. 13, brands are able to create commerce widgets and centrally manage the commerce through a central system. Furthermore, brands can customize and create targeted campaigns.

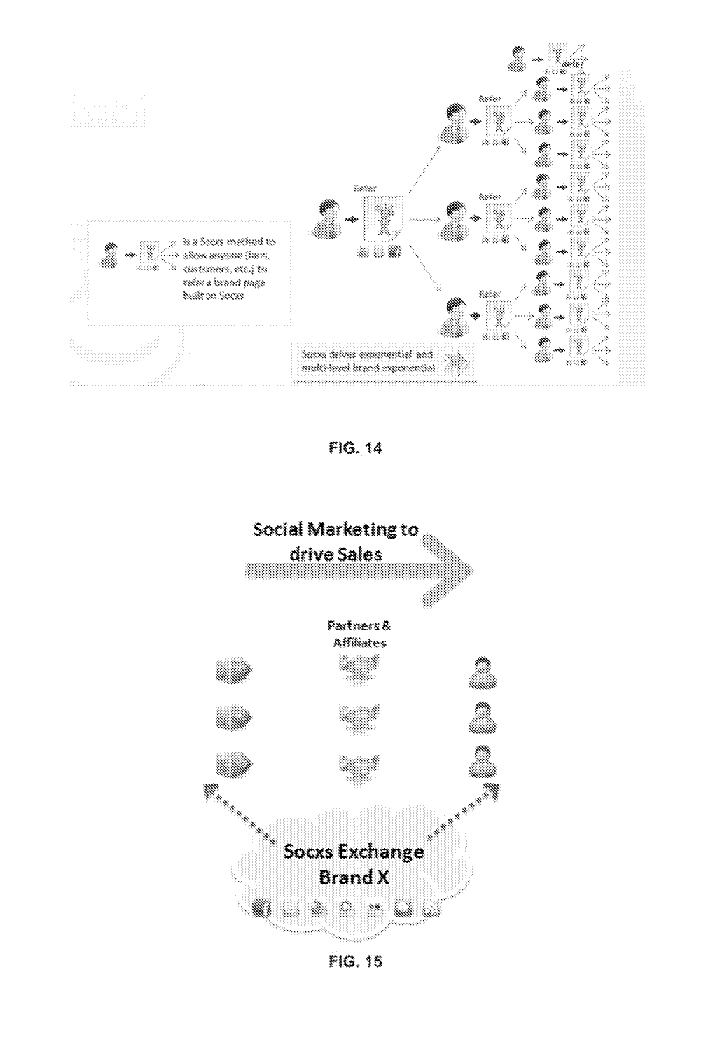

FIG. 14 shows an exemplary referral system according to certain embodiments of the present invention. In the embodiment of FIG. 14, users can refer anyone to brands. The referrals can be tracked the referral tree for each users can be evaluated for rewards, etc.

FIG. 15 shows an exemplary method of social marketing according to certain embodiments of the present invention. In the embodiment of FIG. 15, a central brand management platform to drive marketing, sales, promotions, campaigns, public relations, etc. in a multi-channel environment.

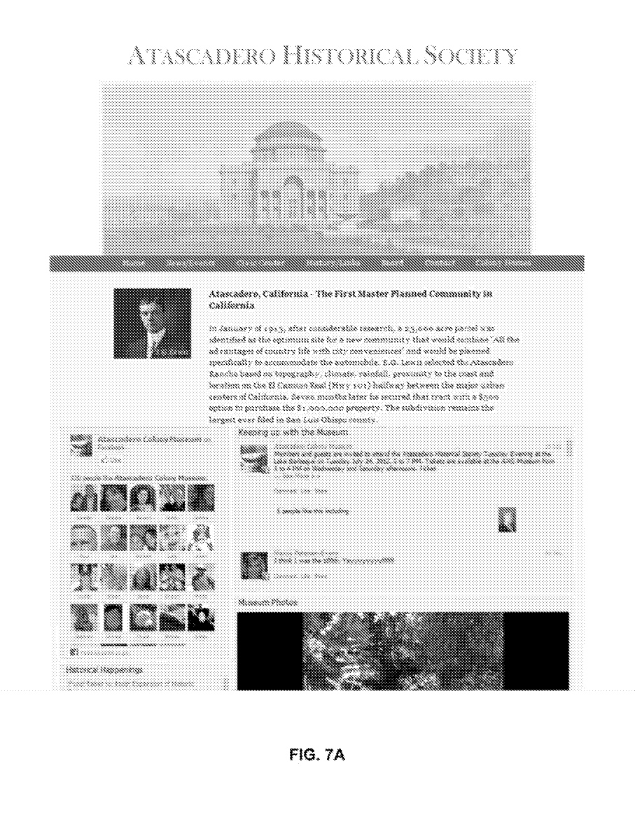

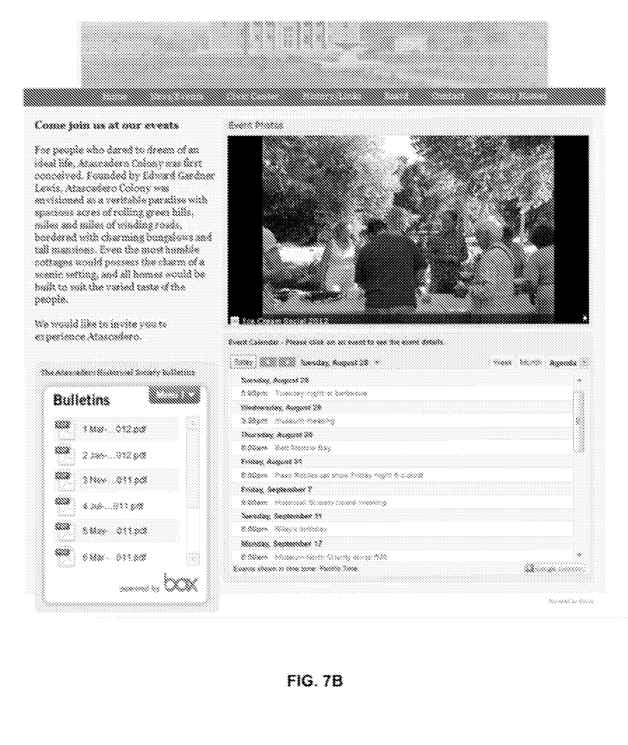

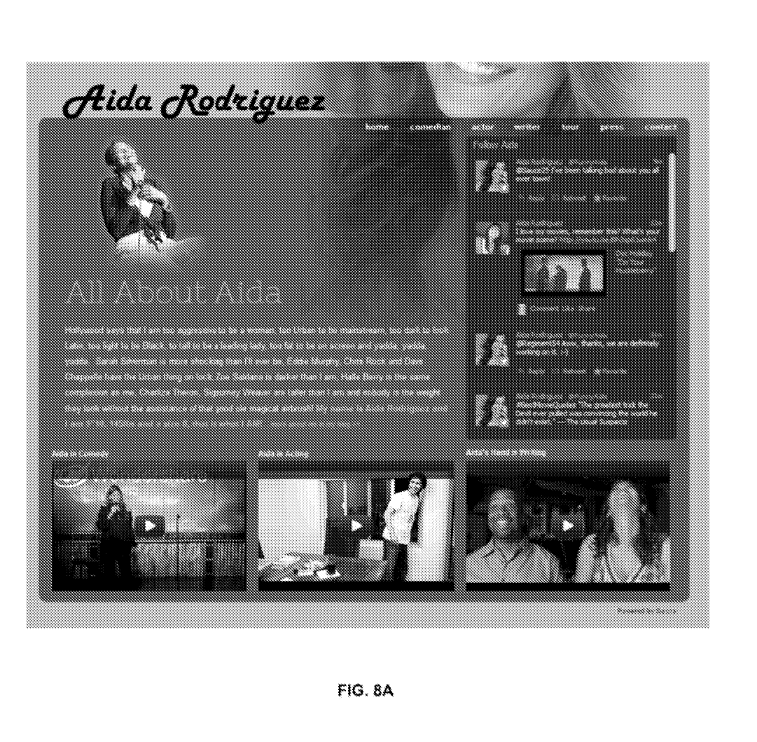

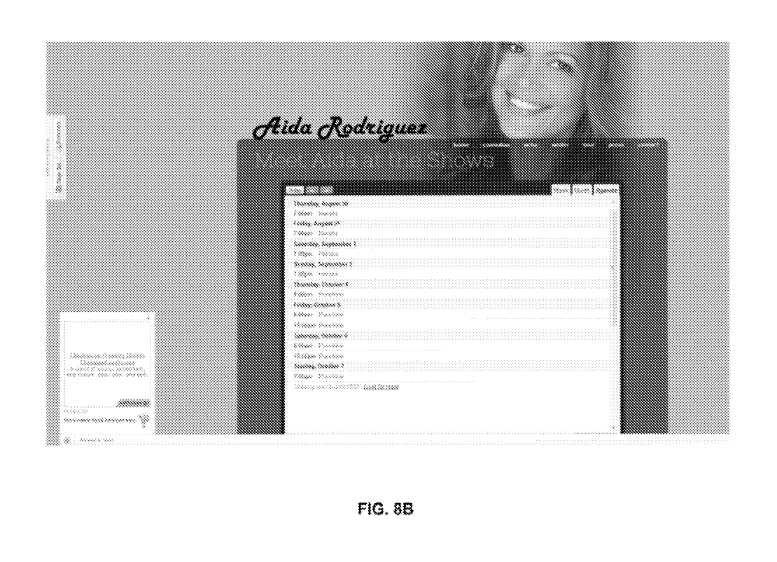

The viewer experience for LiveEvents or Supersites can be custom designed by the administrator of the LiveEvent or Supersite. As described herein content from various feed stream sources can be aggregated in custom designed and grouped format including with additional artwork and characteristics not drawn from feedstream sources. Examples of actual Socxs LiveEvent pages are shown in FIGS. 7a and b and 8a and b.

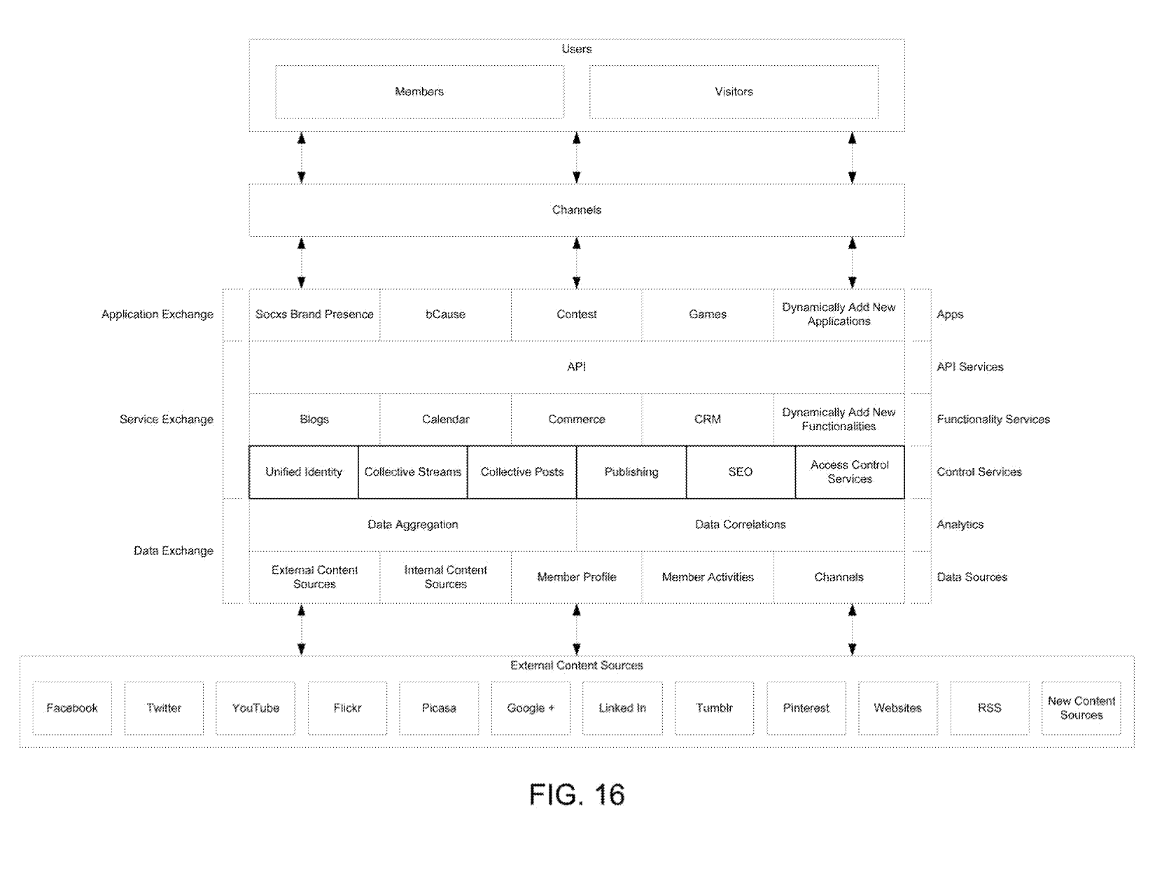

FIG. 16 illustrates an example of a social exchange stack (or Socxs exchange stack) according to one or more embodiments of the present invention. As shown in FIG. 16, the system stack cart comprise three separate stacks. These can comprise Data Exchange; Service Exchange; and Application Exchange (App Exchange). It should be noted that more or less than three stacks can be used.

Information can flow easily, i.e. be exchanged easily, across not only the same stack, but also any stacks above and below it. For example, this can comprise exchange of info within the stacks or exchange of info above and below the stacks.

The data exchange can comprise 2 sub-stacks. These sub-stacks can comprise data sources and analytics. It should be noted that more than two or less than two sub-stacks can be used Data sources can comprise external content sources; internal content sources; member profiles; member activities: channels; and the like. The analytics can comprise data aggregation, and data correlations. The data exchange can aggregate, link, unify, and correlate the data objects for meaningful Analytics. Each stack in Data Exchange is designed to be extensible to allow new data sources and analytics functions to be added on. Furthermore, each item in the stack can be called separately as needed.

The service exchange can comprise three sub-stacks. The sub-stacks can comprise Control Services; Functionality Services; and API Services. It should be noted that more than two or less than three sub-stacks can be used.

The Control Services sub-stack can provide services to enable seamless exchange of data, streams, identity, access, and publishing across all objects. It goes beyond 2-way exchange of info. It allows information for all objects to How seamlessly throughout the system. The controlled services sub-stack can comprise a unified identity structure, a collective steams structure; a collective posts structure; a publishing structure; a SEO structure; and an access control services structure. It should be noted that more or less structures may be contained within the controlled services sub-stack.

The Functionality Services sub-stack can provide integratable functionality as services to support user level tasks such as blogging, calendaring, commerce, etc. The functionality service sub-stack can comprise a blogs structure, a calendar structure; a commerce structure; a CRM structure; and a dynamically add new functionalities structure. It should be noted that more or less structures may be used.

The API Services sub-stack can provide an interface to allow the application exchange to easily call the service and data exchange stack easily.

Each sub-stack in the service exchange stack can be extensible to allow new services, functionalities and API to be added on. Furthermore each sub-stack in the service exchange stack can be modular, such that each item in the stack can be called separately as needed.

The Application Exchange can allow creation and addition of Apps whether by Socxs or 3rd parties. It's an Exchange layer that allows information, to be exchanged among Apps easily and also across the stacks above and below it. There can be info exchange in the App Exchange stack and info exchange across the stacks above and below it

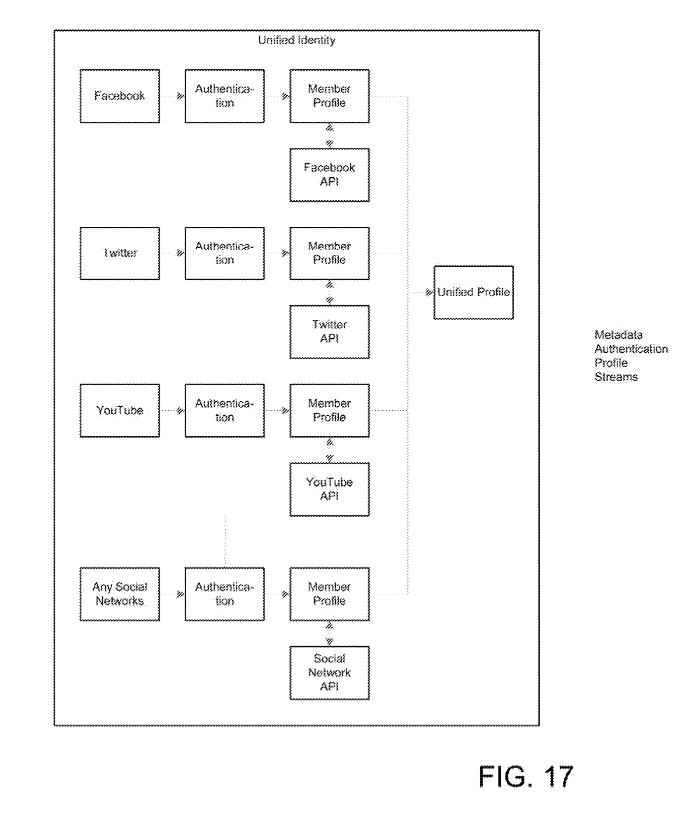

FIG. 17 illustrates an example of a unified identity structure of the service exchange according to one or more embodiments of the present invention. The unified identity structure can map each member's social profile—from all the disparate social networks and profile external sources—into a unified social profile across. For example, for Member X, the Socxs unified identity would create a map of all of Member X's different profiles on Facebook, YouTube, Twitter, etc.

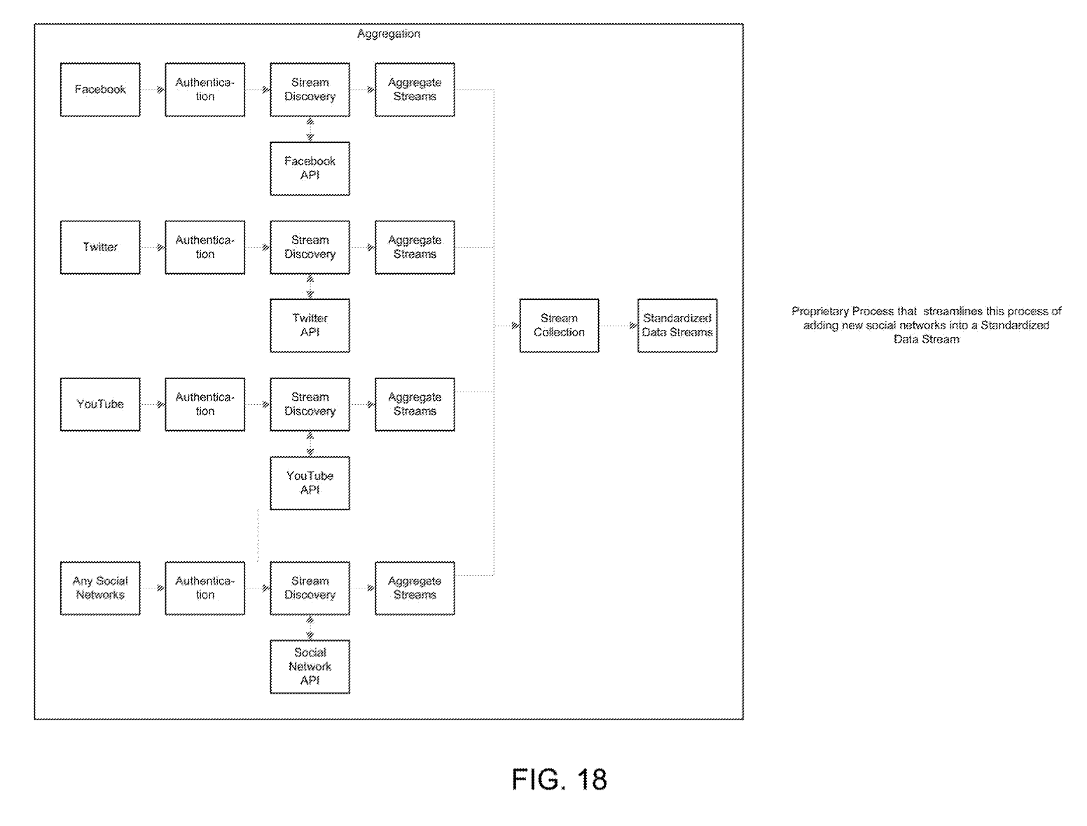

FIG. 18 illustrates an example of a collective streams structure of the service exchange according to one or more embodiments of the present invention. The collective streams structure can map each member's social profile—from all the disparate social networks and profile external sources—into a unified social profile. For example, for Member X, the Socxs unified identity would create a map of all of Member X's different profiles on Facebook, You Tube, Twitter, etc. This collective streams structure can be used across any social network (or any non-social network).

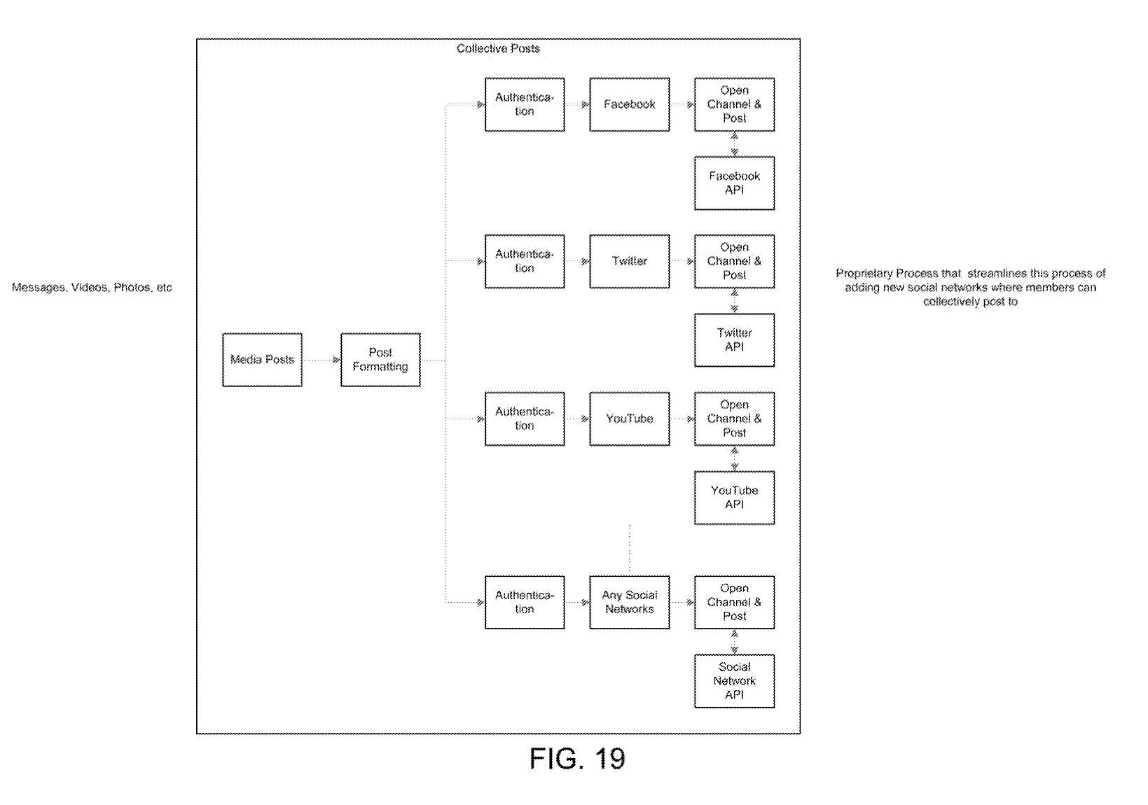

FIG. 19 illustrates an example of a collective posting structure of the service exchange according to one or more embodiments of the present invention. The collective posting structure can allow media to he posted back to the collective streams of the member's collective streams. The user can provide ‘one, all, or selected streams’ for post back. The post back action can be available to BOTH members and visitors of the brand presence. The Socxs method can support post of any media format messages, videos, photos, etc.—to the external sources. Embodiments within can streamline the process of each post and optimize and format the media of the post according to the standards established by the respective external sources.

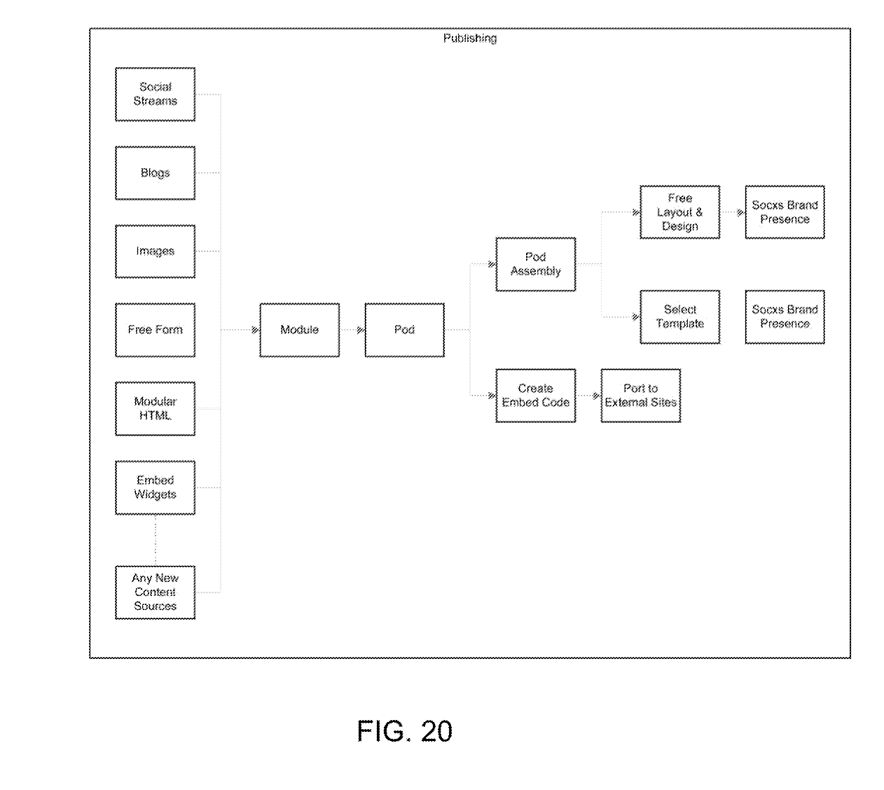

FIG. 20 illustrates an example of a publishing structure of the service exchange according to one or more embodiments of the present invention. The publishing structure allows any content sources to be exchanged and created for publishing for user consumption. Each module can be further published as a Socxs Pod that can be either assembled in a Socxs Brand Presence, or embedded externally in any external site. Each pod can be assembled together just into Free Layout & Design, whereby the member can freely create his/her own brand presence, or a template, whereby the member selects a predefined template.

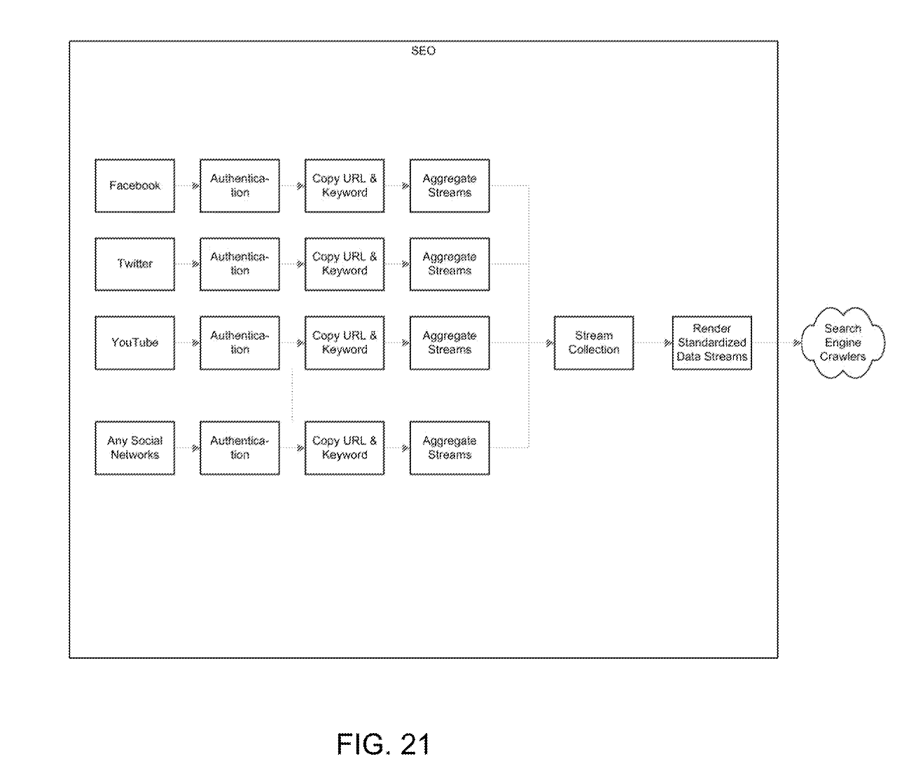

FIG. 21 illustrates an example of a SEO structure of the service exchange according to one or more embodiments of the present invention. Traditionally, Social Content, is completely invisible to Search Engines because it is rendered on the “client side” via JavaScript (or similar language) which Search Engines ignore. However, the present invention renders the content on the page, whereby it Is now indexed by Search Engines. According to one example:

1. Authenticate and Authorize Socxs with 3rd Party Social Content Provider

2. Copy URL or keyword and send to Socxs

3. Socxs defines a live Aggregate Social Streams via backend API

4. Socxs standardizes streams into a Stream Collection for render

5. Socxs renders streams directly on brand presence in an SEO friendly manner.

One SEO tactic that Search. Engines have penalized is copying content on multiple pages. A concern that we render Social Content that is originally sourced on a different, page. But fully this is addressed by:

1. The interspersing of multiple Social Feeds creating a multi-threaded feed which, is now unique and expanded from the original feeds.

2. Some networks not currently indexed by Search Engines at all, so this is “new content” to the Engines altogether. In fact, it helps Search Engines as it gives access to content, that is otherwise locked inside a 3rd party Social Network such as Facebook.

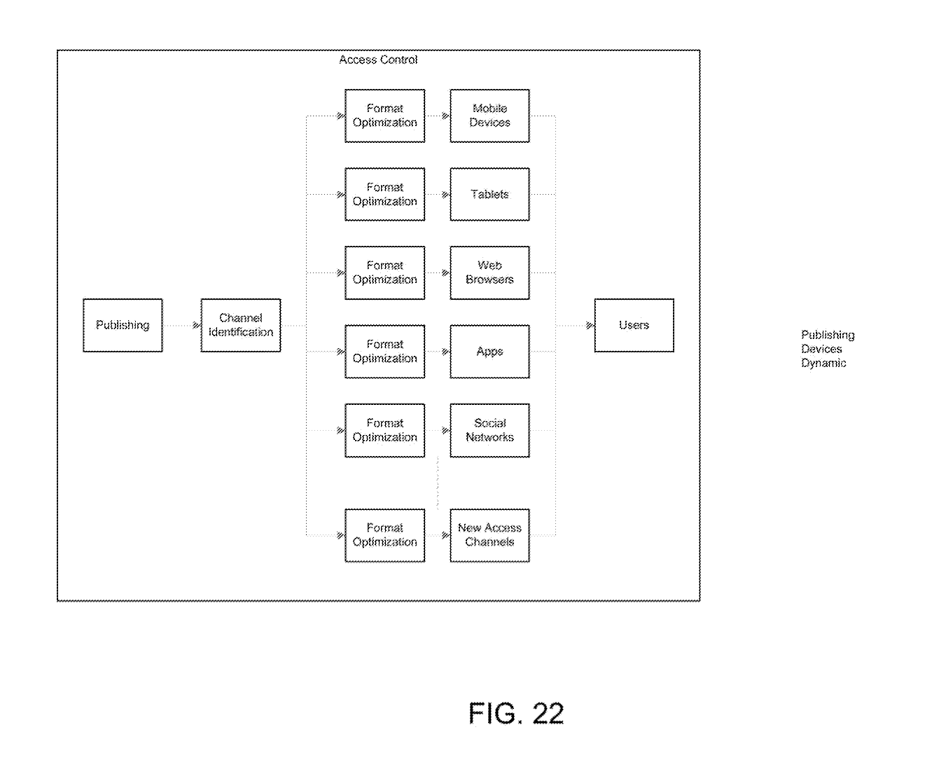

FIG. 22 illustrates an example of an access control services structure of the service exchange according to one or more embodiments of the present invention. The access control services structure enables visitor's access across all Channels. The access control definition automatically detects the devices where the visitors are coming from and appropriately serve the optimized and appropriately formatted brand experience to the visitors. This Access Control Definition is fully extensible to support a growing number of access channels.

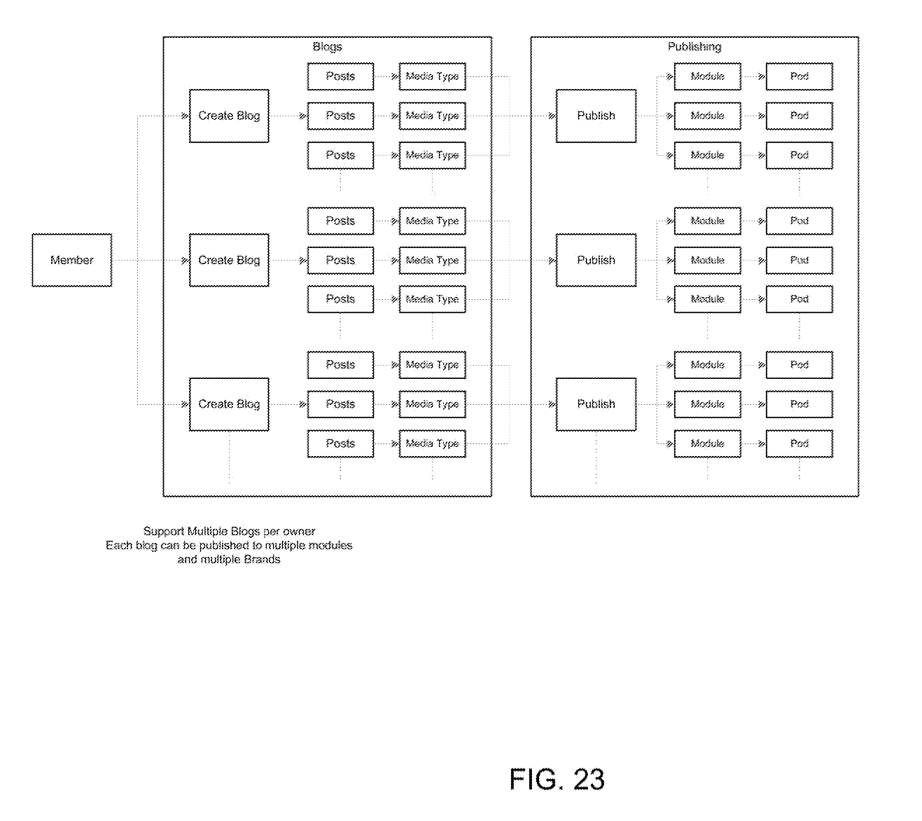

FIG. 23 illustrates an example of a blogs structure of the service exchange according to one or more embodiments of the present invention. The blogs structure may allow members to create posts and messaging on the brand page. Each brand presence can support multiple blogs. In addition, each blog can support multiple posts. Furthermore, each post can be of different media type or a. combination of media type, such as, for example, text, video, audio, images, etc. The blogs structure can further enable each Blog to be ported and embedded across Socxs Brands and. even external sites via Pods

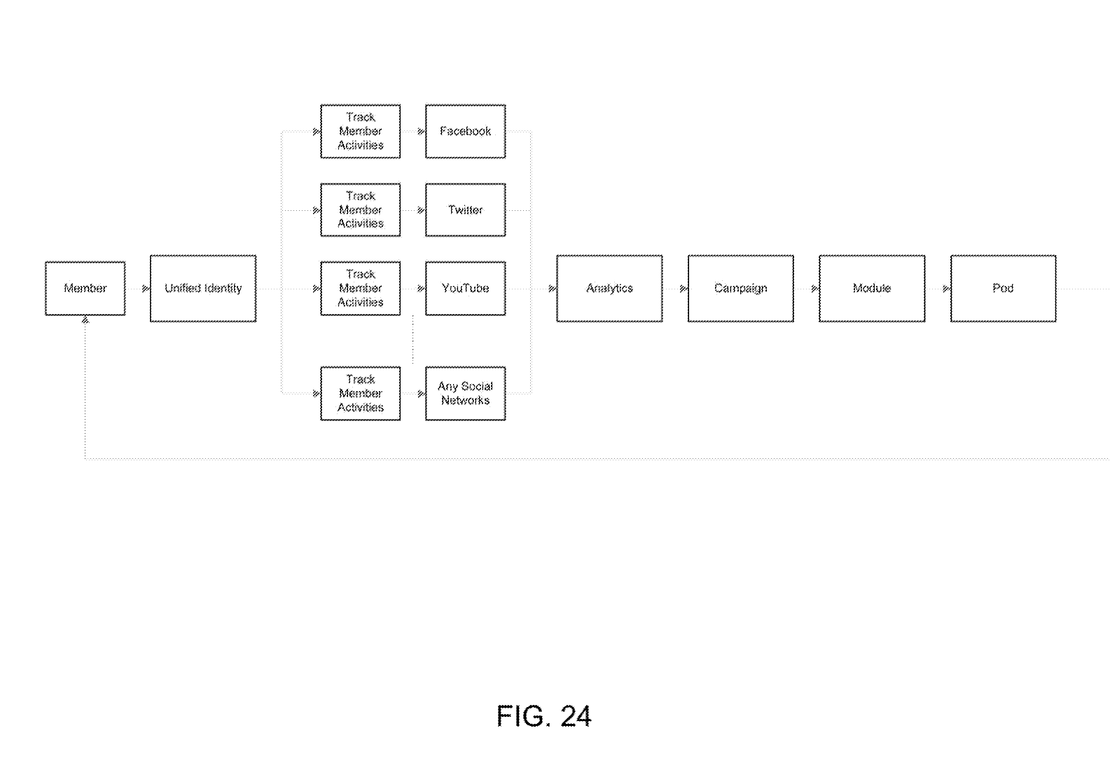

FIG. 24 Illustrates an example of a CRM structure of the service exchange according to one or more embodiments of the present invention. The CRM structure can create a unified social identity from the member profile across all external content sources. The Unified Social Identity tracks Information such as, for example demographic, geographic, interest, etc. The CRM structure can also help track member activities, such as, for example, clicks, behaviors, media preferences & activities, external Content Source preferences & activities, brand pages preferences & activities, etc. Member Profile and Member Activities create a rich and comprehensive member database that allows brands to create and target campaigns to the members. The relation of each member can also be tracked to create an exchange of data of all members in the Socxs system. The Analytics can drive Campaign to the members. Campaigns are created into Socxs Modules and hence Socxs Pods that can he ported anywhere internally within Socxs or externally to sites outside of Socxs.

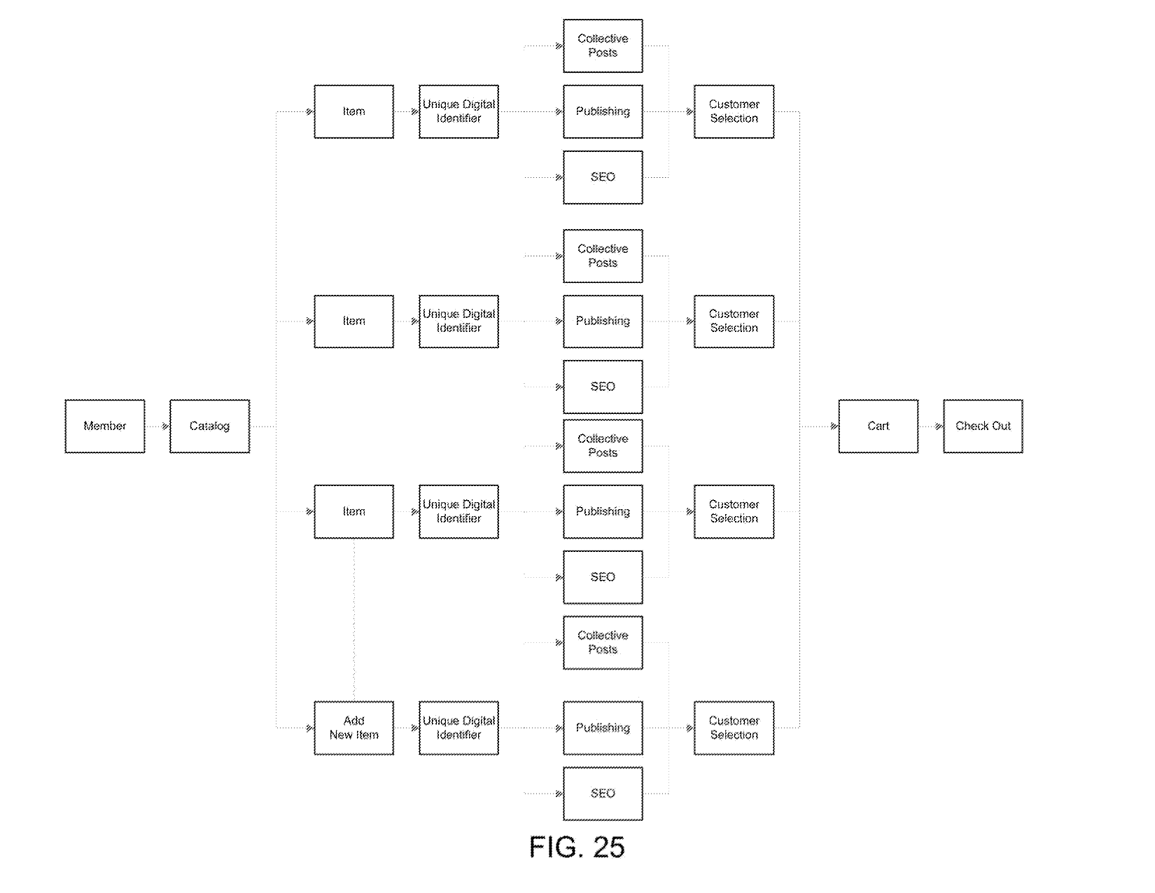

FIG. 25 illustrates an example of a commerce structure of the service exchange according to one or more embodiments of the present invention. The commerce structure can allow members to set up their own catalog that they can sell into not just the web, but also social and mobile channels. Member can also add items to the catalog. Each item can have a unique identifier that can be post, published, and search index out to the all the Channels. Customer selections can be tracked back to the cart for check out.

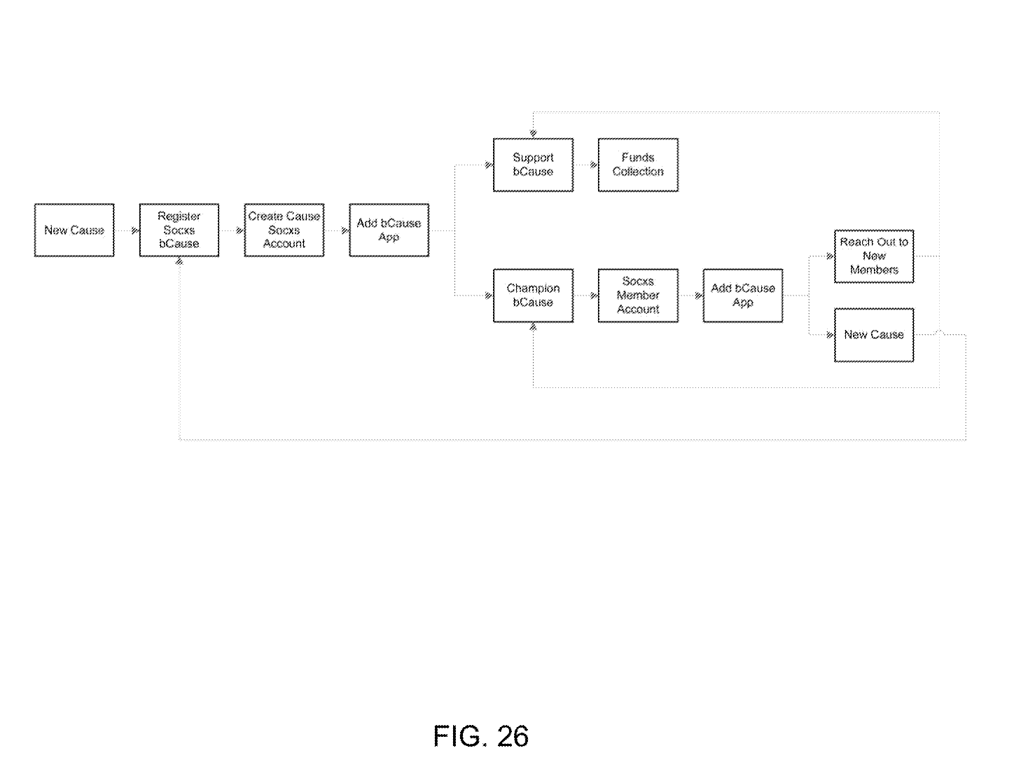

FIG. 26 illustrates an example of an application that is enabled by the Socxs platform. The example of FIG. 26 comprises a bCause application. bCause uses the Socxs platform to unify and integrate the power of web, social and mobile technologies to allow causes (which is the brands in this ease) to create new markets, increase donor engagement and drive more personal, year-round funding opportunities. bCause creates a unique interactive relationship between the cause, the volunteer and the contributor. It stimulates grassroots fundraising by simplifying donor acquisition, tracking, and two-way communication.

Being able to instantly empower personal volunteer networks with social media is a compelling new paradigm for fundraising. With bCause, every volunteer builds his/her own individual network through personal outreach, among friends, family and co-workers while collectively supporting their chosen nonprofit organization. bCause turns each volunteer into a personal champion for the cause while also acknowledging the volunteer for their personal efforts on behalf of the cause.

Embodiments of the present invention can comprise bCause app that enables fundraising for causes. The bCause platform can be built as a standalone from the Socxs Social Platform. In some embodiments it can be used on platforms other than the Socxs Social Platform. The bCause platform can also be used in non-fundraising situations, such as, for example, commercial sales. In some embodiments of the present invention, the systems and methods described herein can be used in many situations in which an individual or organization wants to communicate with particular associated individuals or organizations.

According to aspects of the embodiments disclosed herein, users are allowed to create a turnkey solution to ‘socially power’ events that are in support of fund-raising for causes; to enable an army of campaigners to canvass for causes; to collect commission based revenue for each dollar raised; and do many other things.

In many instances fundraising is a difficult task in which organizers have difficulty reaching potential donors. Furthermore, such organizers have difficulty keeping a donors attention throughout the year.

Embodiments of the present invention allow an organization to create a page, such as, for example, a Socxs page. The organization can use this page, and the power of the Socxs network, to use many different social networking

Example of the bCause app:

A perpetual network can be created using systems and methods described herein. For example, a charitable organization (which is working for a Cause) can use social networks to maintain constant communication with its supporters. One such example is the Socxs network, which allows its users to accumulate many different social networking feeds cm one platform.

The charitable organization can rally its supporters, or champions. The champions can reach out to their friends, family, and acquaintances. The friends, family, and acquaintances of the champions can donate money to the charitable organization by way of the donor, or even, become champions themselves.

The Cause can have its own ‘Cause Page’. This can he the Landing Page for the Cause. In some embodiment, the Cause Page can be located within the Socxs Rally Network. The Cause page can simplify web, social, and mobile platforms. For example. If can bring media from around all the popular social networks for the Cause into the Cause Page. The landing page is accessible via the Web, Mobile Devices, and Social Networks. The Cause Page can be sent out to sign up Champions.

The Cause can use the Cause Page to sign up champions. For example, from the Cause Page, the Cause Director can sign up Champions. In addition, each Champion can have his or her own ‘Champion Page’ in the Socxs Rally Network. Furthermore, according to some embodiments, each Champion Page can be a unique page. In some embodiments, the Champion Page (or Cause Page) can track a champion's progress for Cause and/or track the donors to the champions.

The Champions can use their pages to reach out to friends, family, or anyone person or organization to gain support for the Cause. For example, Champion can send friends and family to his/her Champion Page; a Champion can reach out from Champion Page on Face-book, Twitter, and even emails; and funds collected from Champion Page can be tracked as progress to the particular Champion.

In some embodiments, not only can donors contribute monetary funds to the cause or become champions themselves, donors can dedicate contributions to friends and family. In the same or other embodiments this can be further accomplished with a personal picture and/or message.

Embodiments describe herein can also comprise a leader board. Champions and donors can be tracked to their respective Causes. For each Cause, there can be a leader board showing champions and donors.

In some embodiments, it is possible that an individual or organization can be a champion to more than one cause. In addition, in some embodiments, the systems and methods described herein can be used for for-profit organizations.

Besides unifying the web, social, mobile, bCause adds the concept of gaming to enable Champions and Donors (or Contributors) to compete in a leader board ranking.

FIG. 26 provides an illustration of the example explained above.

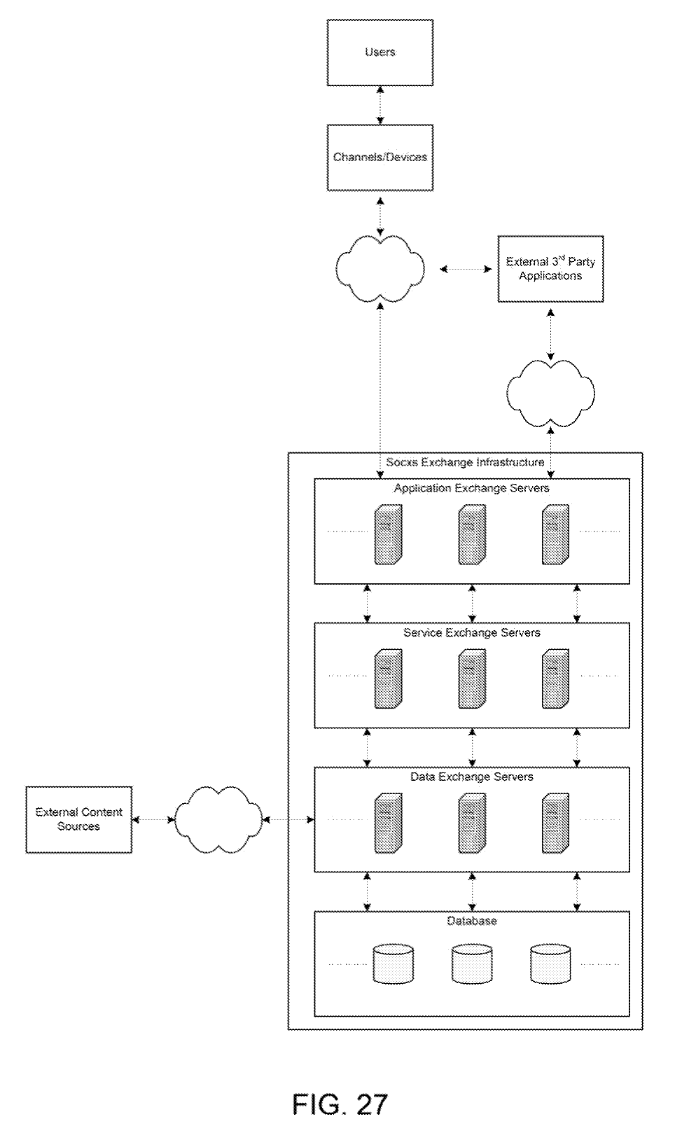

FIG. 27 illustrates an example of a system for allowing exchanges according to one or more embodiments of the present invention. The infrastructure illustrated in FIG. 27 creates a nexus to allow for exchanges among disparate entities (web, social, mobile, channels, users, etc.) to communicate and transfer information easily, It is in a distributed architecture that has the different tiers as shown in FIG. 27. As the software services are extensible, the physical infrastructure too is extensible to allow not only support of new services, functionalities, and applications, but also to scale with growing demand. FIG. 27 should be considered an example and many different system architectures can be used.

Appendix 1 and Appendix 2, attached hereto, include examples of embodiments of the present invention. In some examples, Appendices 1 and 2 can comprise examples of crowd inversion processes. In the same or other examples, Appendices 1 and 2 can comprise examples of crowd inversion processes for advertising.

Although the invention has been described with reference to specific embodiments, it will be understood by those skilled in the art that various changes may be made without departing from the spirit or scope of the invention. Accordingly, the disclosure of embodiments of the Invention is intended to be illustrative of the scope of the invention and is not intended to be limiting. It is intended that the scope of the invention shall be limited only to the extent required by the appended claims. To one of ordinary skill in the art, it will be readily apparent that the systems and methods discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

For simplicity and clarity of illustration, the figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and In the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left;” “right;” “front,” “back,” “top,” “bottom;” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc, in question is or is not removable. For example, the recitation of a first electrical device being coupled to a second electrical device does not mean that the first electrical device cannot he removed (readily or otherwise) from, or that it is permanently connected to, the second electrical device.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a system for aggregating data.

2. A method comprising:
aggregating data.

3. A method comprising:
using a system of aggregating data.
